(19) United States
(12) Patent Application Publication
(10) Pub. No.: US 2026/0341788 A1
(43) Pub. Date: Oct. 29, 2026

(54) NONAQUEOUS ELECTROLYTE SOLUTION FOR BATTERIES, LITHIUM SECONDARY BATTERY PRECURSOR, METHOD FOR PRODUCING LITHIUM SECONDARY BATTERY, AND LITHIUM SECONDARY BATTERY

(71) Applicant: MITSUI CHEMICALS, INC., Chuo-ku, Tokyo (JP)

(72) Inventors: Masato EGUCHI, Chuo-ku, Tokyo (JP); Masahiro SUGURO, Chuo-ku, Tokyo (JP); Hidenobu NOGI, Chuo-ku, Tokyo (JP)

(73) Assignee: MITSUI CHEMICALS, INC., Chuo-ku, Tokyo (JP)

(21) Appl. No.: 19/109,593

(22) PCT Filed: Sep. 6, 2023
(86) PCT No.: PCT/JP2023/032532

§ 371 Date: Mar. 7, 2025

(30) Foreign Application Priority Data
Sep. 8, 2022 (JP) 2022-143268

(51) Int. Cl. H01M 10/0567; H01M 4/02; H01M 4/04; H01M 4/525; H01M 10/0525

(52) U.S. Cl. CPC H01M 10/0567; H01M 4/0445; H01M 4/525; H01M 10/0525; H01M 2004/028

(57) ABSTRACT

A non-aqueous electrolytic solution for a battery, the solution containing an additive A as the following compound (I), and a specified additive B, in which a content of the additive A is from more than 0.01% by mass to less than 0.5% by mass with respect to a total amount of the non-aqueous electrolytic solution for a battery. Each R¹¹ independently represents a fluoro group (—F), a hydrocarbon group having from 1 to 8 carbon atoms, optionally containing a fluoro group (—F) as a substituent, or a fluorocarbon group having from 1 to 8 carbon atoms, and h represents an integer from 0 to 4.

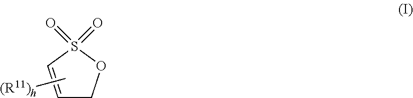

### TECHNICAL FIELD

The present disclosure relates to a non-aqueous electrolytic solution for a battery, a lithium secondary battery precursor, a method of producing a lithium secondary battery, and a lithium secondary battery.

### BACKGROUND ART

In recent years, non-aqueous electrolytic solutions used in batteries such as lithium secondary batteries have been variously studied.

For example, Patent Literature 1 to 6 disclose a non-aqueous electrolytic solution containing 1,3-propenesultone as an additive.
Patent Literature 1: Japanese Patent Application Laid-Open (JP-A) No. 2002-329528
Patent Literature 2: JP-A No. 2008-198542
Patent Literature 3: JP-A No. 2010-92698
Patent Literature 4: JP-A No. 2014-27196
Patent Literature 5: JP-A No. 2018-129169
Patent Literature 6: WO 2019/146705

### SUMMARY OF INVENTION

### Technical Problem

However, a non-aqueous electrolytic solution for a battery, containing 1,3-propenesultone as an additive, may be demanded to have performance for a reduction in initial resistance of a battery.

An object of one aspect of the disclosure is to provide a non-aqueous electrolytic solution for a battery and a lithium secondary battery precursor, which can allow for a reduction in initial resistance of a battery, a lithium secondary battery reduced in initial resistance, and a method of producing a lithium secondary battery.

### Solution to Problem

Solutions for solving the above problems include the following aspects.
<1> A non-aqueous electrolytic solution for a battery, the solution containing:
   an additive A that is a compound (I) represented by the following Formula (I); and
   an additive B that is at least one selected from the group consisting of a compound (II) represented by the following Formula (II), a compound (III) that is at least one of a monofluorophosphate or a difluorophosphate, a compound (IV) represented by the following Formula (IV), a compound (V) represented by the following Formula (V), a compound (VI) represented by the following Formula (VI), a compound (VII) represented by the following Formula (VII), and a compound (VIII) represented by the following Formula (VIII), wherein
   a content of the additive A is from more than 0.01% by mass to less than 0.5% by mass with respect to a total amount of the non-aqueous electrolytic solution for a battery:

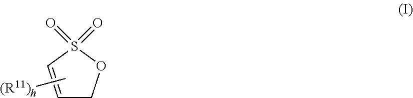

wherein, in Formula (I), each R¹¹ independently represents a fluoro group (—F), a hydrocarbon group having from 1 to 8 carbon atoms, optionally containing a fluoro group (—F) as a substituent, or a fluorocarbon group having from 1 to 8 carbon atoms, and h represents an integer from 0 to 4;

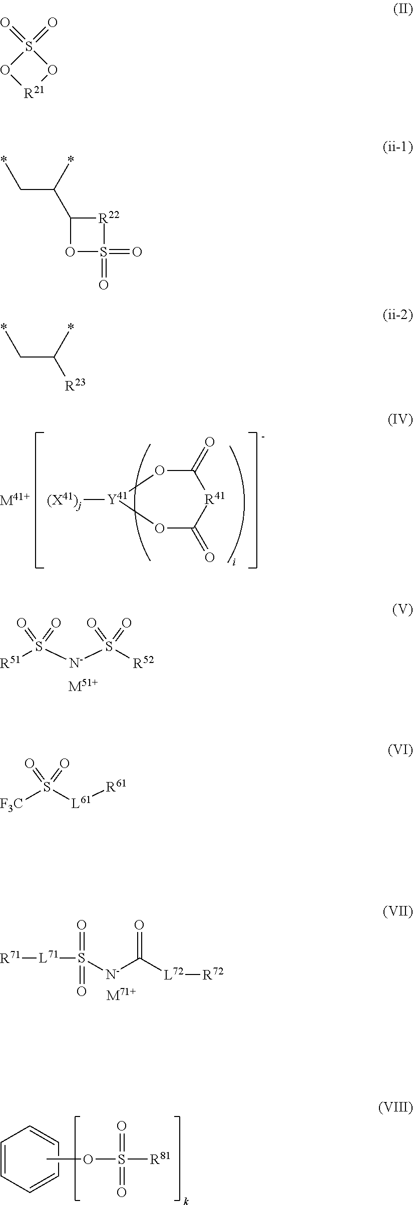

in Formula (II),
R²¹ represents a group represented by Formula (ii-1), a group represented by Formula (ii-2), or a divalent hydrocarbon group having from 3 to 6 carbon atoms,
* represents a binding position,
in Formula (ii-1), R²² represents an oxymethylene group (—OCH₂—), an oxyethylene group (—OCH₂CH₂—), an oxa group (—O—), or a divalent hydrocarbon group having from 1 to 6 carbon atoms, and
in Formula (ii-2), R²³ represents a hydrocarbon group having from 1 to 8 carbon atoms; in Formula (IV),
M⁴¹⁺ represents an alkali metal ion,
each X⁴¹ independently represents a fluoro group (—F), a chloro group (—Cl), a bromo group (—Br), or an iodo group (—I),
Y⁴¹ represents a boron atom or a phosphorus atom,
each R⁴¹ independently represents a single bond (—), or a divalent hydrocarbon group having from 1 to 6 carbon atoms, optionally containing, as a substituent, at least one group selected from the group consisting of a fluoro group (—F), a chloro group (—Cl), a bromo group (—Br), and an iodo group (—I),
i represents 1 or 2 in a case in which the Y⁴¹ is a boron atom, or represents an integer from 1 to 3 in a case in which the Y⁴¹ is a phosphorus atom, and
j represents 0 or 2 in a case in which the Y⁴¹ is a boron atom, or represents 0, 2, or 4 in a case in which the Y⁴¹ is a phosphorus atom;
in Formula (V),
M⁵¹⁺ represents an alkali metal ion, and
each of R⁵¹ and R⁵² independently represents a fluoro group (—F), a hydrocarbon group having from 1 to 3 carbon atoms, optionally containing a fluoro group as a substituent, or a fluorocarbon group having from 1 to 3 carbon atoms;
in Formula (VI),
R⁶¹ represents a hydrocarbon group having from 1 to 8 carbon atoms, optionally containing, as a substituent, at least one group selected from the group consisting of a fluoro group (—F), a chloro group (—Cl), a bromo group (—Br), an iodo group (—I), an oxa group (—O—), a thio group (—S—), a secondary amino group (—NH—), a tertiary amino group (—N<), a carbonyl group (>C═O), and a sulfonyl group (>S(═O)₂), and
L⁶¹ represents a single bond (—) or an oxa group (—O—);
in Formula (VII),
M⁷¹⁺ represents an alkali metal ion,
each of R⁷¹ and R⁷² independently represents a fluoro group (—F), a chloro group (—Cl), a bromo group (—Br), an iodo group (—I), a hydrocarbon group having from 1 to 12 carbon atoms, optionally containing, as a substituent, at least one selected from the group consisting of a fluoro group (—F), a chloro group (—Cl), a bromo group (—Br), an iodo group (—I), and an oxa group (—O—), or a fluorocarbon group having from 1 to 8 carbon atoms, and
each of L⁷¹ and L⁷² represents a single bond (—) or an oxa group (—O—), and at least one of L⁷¹ or L⁷² is an oxa group (—O—);
in Formula (VIII),
each R⁸¹ independently represents a fluoro group (—F), a chloro group (—Cl), a bromo group (—Br), or an iodo group (—I), and
k represents an integer from 1 to 6.
<2> The non-aqueous electrolytic solution for a battery according to <1>, wherein a content mass ratio of the additive A to the additive B (Content mass of additive A/Content mass of additive B) is from 0.05 to 0.5.
<3> The non-aqueous electrolytic solution for a battery according to <1> or <2>, wherein a content of the additive A is from 0.05% by mass to 0.4% by mass with respect to a total amount of the non-aqueous electrolytic solution for a battery.
<4> The non-aqueous electrolytic solution for a battery according to any one of <1> to <3>, wherein a content of the additive B is from 0.01% by mass to 5.0% by mass with respect to a total amount of the non-aqueous electrolytic solution for a battery.
<5> The non-aqueous electrolytic solution for a battery according to <1>, including the compound (II) as the additive B, wherein a content of the additive B is from 0.01% by mass to 5.0% by mass with respect to a total amount of the non-aqueous electrolytic solution for a battery.
<6> The non-aqueous electrolytic solution for a battery according to <1>, including the compound (III) as the additive B, wherein a content mass ratio of the additive A to the additive B (Content mass of additive A/Content mass of additive B) is from 0.05 to 0.4.
<7> The non-aqueous electrolytic solution for a battery according to <1>, including the compound (IV) as the additive B, wherein a content of the additive B is from 0.01% by mass to 5.0% by mass with respect to a total amount of the non-aqueous electrolytic solution for a battery.
<8> The non-aqueous electrolytic solution for a battery according to <1>, including the compound (V) as the additive B, wherein a content of the additive B is from 0.1 mol/L to 6 mol/L with respect to a total amount of the non-aqueous electrolytic solution for a battery.
<9> A lithium secondary battery precursor including:
a case; and
a positive electrode, a negative electrode, a separator, and an electrolytic solution housed in the case, wherein
the positive electrode is a positive electrode capable of occluding and releasing a lithium ion,
the negative electrode is a negative electrode capable of occluding and releasing a lithium ion, and
the electrolytic solution is the non-aqueous electrolytic solution for a battery according to any one of <1> to <8>.
<10> The lithium secondary battery precursor according to <9>, wherein the positive electrode includes, as a positive electrode active material, a lithium-containing composite oxide represented by the following Formula (X):

LiNiₐCo_{b}Mn_{c}O₂ Formula (X)
wherein, in Formula (X), each of a, b and c is independently from more than 0 to less than 1, and a total of a, b and c is from 0.99 to 1.00.
<11> A method of producing a lithium secondary battery, the method including:
   a step of preparing the lithium secondary battery precursor according to <9> or <10>; and
   a step of applying charge and discharge to the lithium secondary battery precursor.
<12> A lithium secondary battery obtained by applying charge and discharge to the lithium secondary battery precursor according to <9> or <10>.

### Advantageous Effect of Invention

One aspect of the disclosure provides a non-aqueous electrolytic solution for a battery and a lithium secondary battery precursor, which can allow for a reduction in initial resistance of a battery, a lithium secondary battery reduced in initial resistance, and a method of producing a lithium secondary battery.

### BRIEF DESCRIPTION OF DRAWINGS

FIG. 1 A schematic cross-sectional view illustrating a laminate-type battery as one example of the lithium secondary battery precursor of the disclosure.

FIG. 2 A schematic cross-sectional view illustrating a coin-type battery as another example of the lithium secondary battery precursor of the disclosure.

### DESCRIPTION OF EMBODIMENTS

In the disclosure, a numerical value range expressed with “(from) . . . to” means a range including numerical values described before and after “to” respectively as the lower limit value and the upper limit value.

The upper limit value or the lower limit value described by one numerical value range as a numerical value range described stepwise in the disclosure may be replaced with the upper limit value or the lower limit value of any other numerical value range described stepwise. The upper limit value or the lower limit value of any numerical value range as a numerical value range described in the disclosure may be replaced with any value indicated in Examples.

In the disclosure, the amount of each component in a composition means the total amount of a plurality of substances corresponding to each component present in the composition in a case in which the plurality of substances are present in the composition, unless particularly noted.

In the disclosure, a combination of preferred aspects is a more preferred aspect.

In the disclosure, the term “step” encompasses not only an independent step, but also a step which, even in the case of being not clearly distinguishable from any other step, can achieve a predefined object of the relevant step.

### [Non-Aqueous Electrolytic Solution for Battery]

Hereinafter, the non-aqueous electrolytic solution for a battery of the disclosure (hereinafter, also simply referred to as “non-aqueous electrolytic solution”) contains
an additive A that is a compound (I) represented by the following Formula (I), and
an additive B that is at least one selected from the group consisting of a compound (II) represented by the following Formula (II), a compound (III) that is at least one of a monofluorophosphate or a difluorophosphate, a compound (IV) represented by the following Formula (IV), a compound (V) represented by the following Formula (V), a compound (VI) represented by the following Formula (VI), a compound (VII) represented by the following Formula (VII), and a compound (VIII) represented by the following Formula (VIII), wherein
the content of the additive A is from more than 0.01% by mass to less than 0.5% by mass with respect to the total amount of the non-aqueous electrolytic solution for a battery.

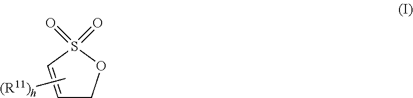

In Formula (I), each R¹¹ independently represents a fluoro group (—F), a hydrocarbon group having from 1 to 8 carbon atoms, optionally containing a fluoro group (—F) as a substituent, or a fluorocarbon group having from 1 to 8 carbon atoms, and h represents an integer from 0 to 4.

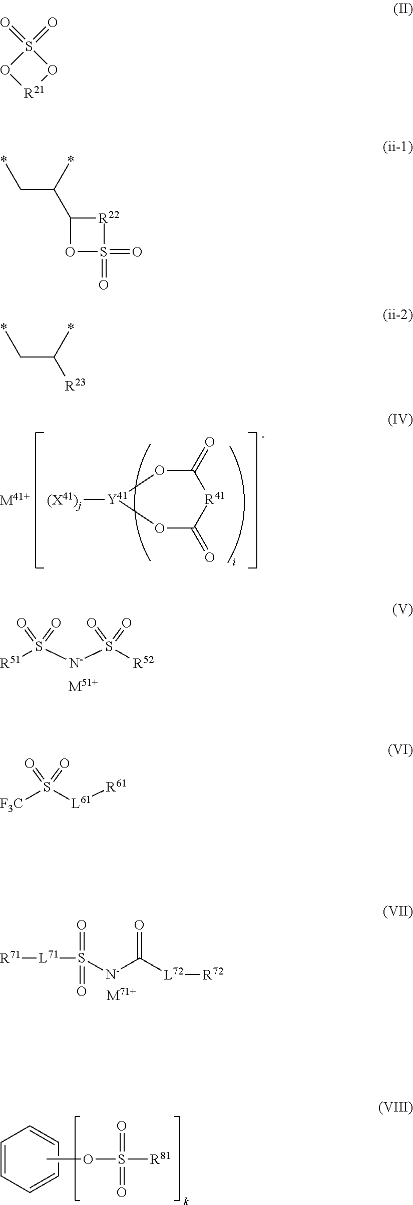

In Formula (II),
R²¹ represents a group represented by Formula (ii-1), a group represented by Formula (ii-2), or a divalent hydrocarbon group having from 3 to 6 carbon atoms,
* represents a binding position,
in Formula (ii-1), R²² represents an oxymethylene group (—OCH₂—), an oxyethylene group (—OCH₂CH₂—), an oxa group (—O—), or a divalent hydrocarbon group having from 1 to 6 carbon atoms, and
in Formula (ii-2), R²¹ represents a hydrocarbon group having from 1 to 8 carbon atoms.

In Formula (IV),
M⁴¹⁺ represents an alkali metal ion,
each X⁴¹ independently represents a fluoro group (—F), a chloro group (—Cl), a bromo group (—Br), or an iodo group (—I),
Y⁴¹ represents a boron atom or a phosphorus atom,
each R⁴¹ independently represents a single bond (—), or a divalent hydrocarbon group having from 1 to 6 carbon atoms, optionally containing, as a substituent, at least one group selected from the group consisting of a fluoro group (—F), a chloro group (—Cl), a bromo group (—Br), and an iodo group (—I),
i represents 1 or 2 in a case in which the Y⁴¹ is a boron atom, or represents an integer from 1 to 3 in a case in which the Y⁴¹ is a phosphorus atom, and
j represents 0 or 2 in a case in which the Y⁴¹ is a boron atom, or represents 0, 2, or 4 in a case in which the Y⁴¹ is a phosphorus atom.

In Formula (V),
M⁵¹⁺ represents an alkali metal ion, and
each of R⁵¹ and R⁵² independently represents a fluoro group (—F), a hydrocarbon group having from 1 to 3 carbon atoms, optionally containing a fluoro group as a substituent, or a fluorocarbon group having from 1 to 3 carbon atoms.

In Formula (VI),
R⁶¹ represents a hydrocarbon group having from 1 to 8 carbon atoms, optionally containing, as a substituent, at least one group selected from the group consisting of a fluoro group (—F), a chloro group (—Cl), a bromo group (—Br), an iodo group (—I), an oxa group (—O—), a thio group (—S—), a secondary amino group (—NH—), a tertiary amino group (—N<), a carbonyl group (>C═O), and a sulfonyl group (>S(═O)₂), and
L⁶¹ represents a single bond (—) or an oxa group (—O—).

In Formula (VII),
M⁷¹⁺ represents an alkali metal ion,
each of R⁷¹ and R⁷² independently represents a fluoro group (—F), a chloro group (—Cl), a bromo group (—Br), an iodo group (—I), a hydrocarbon group having from 1 to 12 carbon atoms, optionally containing, as a substituent, at least one selected from the group consisting of a fluoro group (—F), a chloro group (—Cl), a bromo group (—Br), an iodo group (—I), and an oxa group (—O—), or a fluorocarbon group having from 1 to 8 carbon atoms, and
each of L⁷¹ and L⁷² represents a single bond (—) or an oxa group (—O—), and at least one of L⁷¹ or L⁷² is an oxa group (—O—).

In Formula (VIII),
each R⁸¹ independently represents a fluoro group (—F), a chloro group (—Cl), a bromo group (—Br), or an iodo group (—I), and
k represents an integer from 1 to 6.

It has been revealed by studies of the present inventors that a non-aqueous electrolytic solution for a battery, containing an additive A typified by 1,3-propenesultone, has room for more improvement of performance for a reduction in initial resistance of a battery.

It has been specifically revealed that, in a case in which an additive A and an additive B are used in combination and the content of the additive A with respect to the total amount of the non-aqueous electrolytic solution for a battery (hereinafter, also simply referred to as “content of the additive A”) is 0.5% by mass or more, the initial resistance of a battery tends to be higher.

In this regard, it has revealed that, also in a case in which an additive A and an additive B are used in combination and the content of the additive A is 0.01% by mass or less, the initial resistance of a battery tends to be higher.

In order to address the above problem about the initial resistance, the content of the additive A in the non-aqueous electrolytic solution of the disclosure is restricted in a range of from more than 0.01% by mass to less than 0.5% by mass.

Thus, the initial resistance of a battery can be reduced.

### <Additive A>

The non-aqueous electrolytic solution of the disclosure contains an additive A that is the compound (I) represented by the Formula (I).

The additive A (namely compound (I)) contained in the non-aqueous electrolytic solution may be adopted singly, or in combination of two or more kinds thereof.

The compound (I) is an unsaturated sultone compound, as in the above structure.

In Formula (I), each R¹¹ independently represents a “fluoro group (—F)”, a “hydrocarbon group having from 1 to 8 carbon atoms, optionally containing a fluoro group (—F) as a substituent”, or a “fluorocarbon group having from 1 to 8 carbon atoms”, and h represents an integer from 0 to 4. In Formula (I), a structure is drawn in which a binding line of (R¹¹)ₕ sticks a five-membered ring of unsaturated sultone, and this structure means that each of four hydrogen atoms contained in a five-membered ring ( . . . S—CH═CH—CH₂—O . . . ) of unsaturated sultone is independently optionally substituted with a “fluoro group (—F)”, a “hydrocarbon group having from 1 to 8 carbon atoms, optionally containing a fluoro group (—F) as a substituent”, or a “fluorocarbon group having from 1 to 8 carbon atoms”. The “hydrocarbon group” is not limited to an aliphatic hydrocarbon group having a linear structure, and means that the group may be a group having at least one structure selected from the group consisting of a branched structure, a cyclic structure, or a carbon-carbon unsaturated bond structure (carbon-carbon double bond structure or a carbon-carbon triple bond structure), or may be an aromatic hydrocarbon group. In other words, all of an alkyl group, an alkenyl group, an alkynyl group, an aryl group, and the like are encompassed in the “hydrocarbon group”. The “optionally containing, as a substituent, a fluoro group (—F)” means that not only a hydrocarbon group not containing a fluoro group (—F) as a substituent is encompassed, but also a hydrocarbon group in which some hydrogen atoms are each substituted with a fluoro group (—F) is encompassed, provided that the number of fluoro groups (—F) is not particularly limited. The “fluorocarbon group” means a group in which all hydrogen atoms in a hydrocarbon group are substituted with fluoro groups (—F). The “number of carbon atoms” means the number of carbon atoms including carbon atom(s) of a substituent in the case of the “hydrocarbon group” or the “fluorocarbon group” having such a substituent, and, for example, the number of carbon atoms in a trifluoromethylphenyl group (—C₆H₅CF₃) is considered in a way in which 7 obtained by adding a number of carbon atoms of 6 in a phenyl group and a number of carbon atoms of 1 in a trifluoromethyl group serves as the number of carbon atoms of a trifluoromethylphenyl group (—C₆H₅CF₃) as a hydrocarbon group containing a fluoro group (—F).

In a case in which R¹¹ is a “hydrocarbon group having from 1 to 8 carbon atoms, optionally containing a fluoro group (—F) as a substituent” or a “fluorocarbon group having from 1 to 8 carbon atoms”, the number of carbon atoms of each of such hydrocarbon group and fluorocarbon group is preferably 6 or less, more preferably 5 or less, still more preferably 4 or less, particularly preferably 3 or less.

R¹¹ is preferably a fluoro group (—F), an alkyl group having from 1 to 8 carbon atoms, an alkenyl group having from 2 to 8 carbon atoms, an alkynyl group having from 2 to 8 carbon atoms, an aryl group having from 6 to 8 carbon atoms, an alkyl group having from 1 to 8 carbon atoms, containing a fluoro group (—F), an alkenyl group having from 2 to 8 carbon atoms, containing a fluoro group (—F), an alkynyl group having from 2 to 8 carbon atoms, containing a fluoro group (—F), an aryl group having from 6 to 8 carbon atoms, containing a fluoro group (—F), a perfluoroalkyl group having from 1 to 8 carbon atoms, a perfluoroalkenyl group having from 2 to 8 carbon atoms, a perfluoroalkynyl group having from 2 to 8 carbon atoms, or a perfluoroaryl group having from 6 to 8 carbon atoms, particularly preferably a fluoro group (—F), a monofluoromethyl group (—CH₂F), a difluoromethyl group (—CHF₂), a trifluoromethyl group (—CF₃), a methyl group (—CH₃), or an ethyl group (—CH₂CH₃).

h is an integer from 0 to 4, preferably 0, 1, or 2, more preferably 0 or 1, particularly preferably 0. It is noted that h being 0 refers to no presence of R¹¹ and means that 1,3-propenesultone is formed.

Specific examples of the compound (I) include the following compound (I-1) to the following compound (I-21), and the compound (I) is not limited to these specific examples.

Among them, the compound (I-1) is particularly preferred.

The compound (I-1) is 1,3-propenesultone.

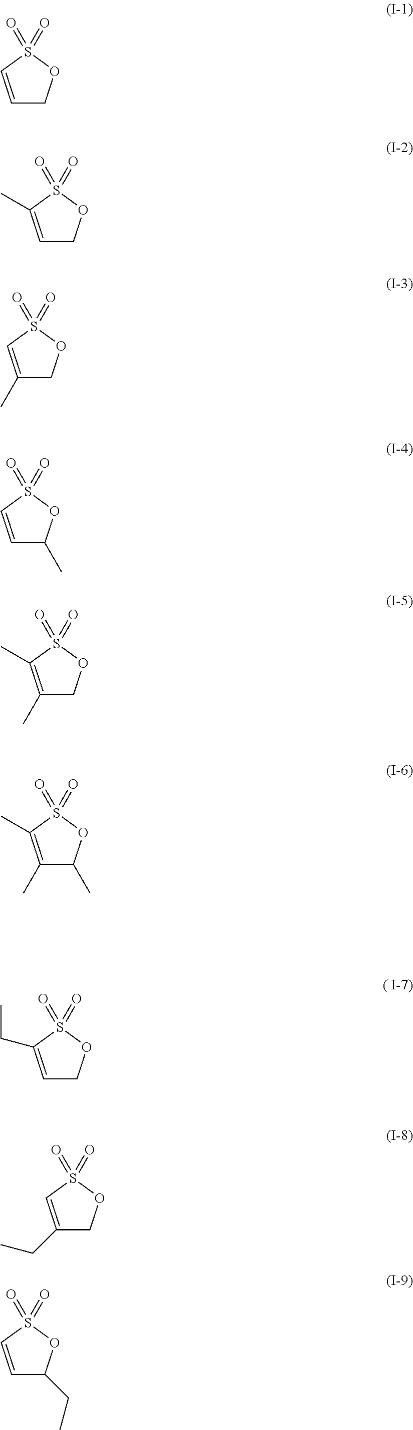

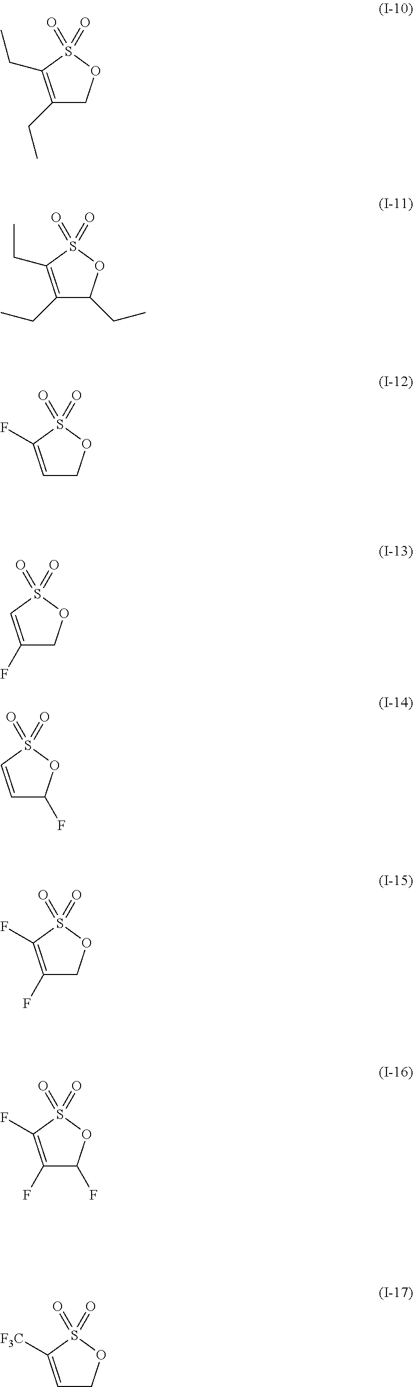

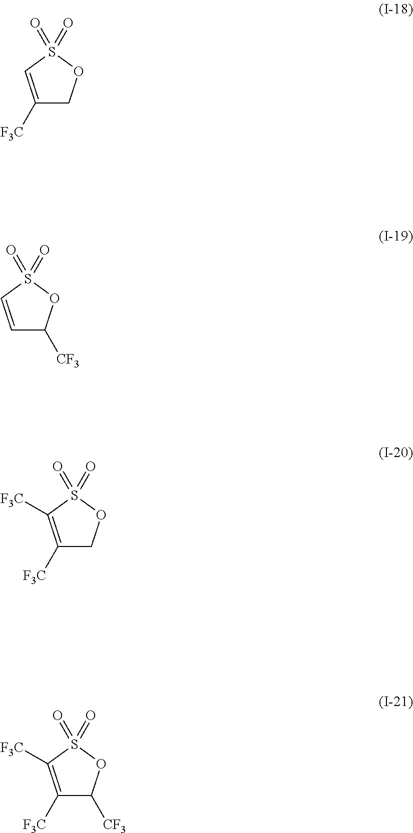 [SMILES: O=S1(=O)C=C(C(F)(F)F)CO1 ; O=S1(=O)C=CC(C(F)(F)F)O1 ; O=S1(=O)OCC(C(F)(F)F)=C1C(F)(F)F ; O=S1(=O)OC(C(F)(F)F)C(C(F)(F)F)=C1C(F)(F)F]

The content of the additive A (namely, compound (I)) with respect to the total amount of the non-aqueous electrolytic solution is from more than 0.01% by mass to less than 0.5% by mass.

Thus, performance for a reduction in initial resistance of a battery is enhanced as compared with the case of 0.01% by mass or less of the additive A and the case of 0.5% by mass or more of the additive A.

The content of the additive A is preferably 0.02% by mass or more, more preferably 0.03% by mass or more, still more preferably 0.04% by mass or more, and preferably 0.4% by mass or less, more preferably 0.3% by mass or less, still more preferably 0.2% by mass or less from the viewpoint of the effects by the non-aqueous electrolytic solution of the disclosure can be more effectively obtained. The content can also be 0.05% by mass or more, 0.1% by mass or more.

### <Additive B>

The non-aqueous electrolytic solution of the disclosure contains an additive B that is at least one selected from the group consisting of the compound (II) represented by Formula (II), the compound (III) that is at least one of a monofluorophosphate or a difluorophosphate, the compound (IV) represented by Formula (IV), the compound (V) represented by Formula (V), the compound (VI) represented by Formula (VI), the compound (VII) represented by Formula (VII), and the compound (VIII) represented by Formula (VIII).

Only one, or two or more such additives B may be contained in the non-aqueous electrolytic solution.

The content of the additive B with respect to the total amount of the non-aqueous electrolytic solution for a battery is usually from 0.01% by mass to 5.0% by mass from the viewpoint of the effects by the non-aqueous electrolytic solution of the disclosure can be more effectively obtained, and is preferably 0.03% by mass or more, more preferably 0.05% by mass or more, still more preferably 0.1% by mass or more, particularly preferably 0.3% by mass or more, and preferably 3.0% by mass or less, more preferably 2.0% by mass or less, still more preferably 1.0% by mass or less, particularly preferably 0.9% by mass or less. The content can also be 0.8% by mass or less, 0.6% by mass or less.

The content mass ratio of the additive A to the additive B (namely, the ratio between the content mass of the additive A and the content mass of the additive B, which is the ratio obtained by dividing the content mass of the additive A by the content mass of the additive B; hereinafter, also referred to as “content mass ratio [additive A/additive B]”) in the non-aqueous electrolytic solution of the disclosure is usually from 0.05 to 0.5 from the viewpoint of the effects by the non-aqueous electrolytic solution of the disclosure can be more effectively obtained, and is preferably 0.06 or more, preferably 0.45 or less. The content can also be 0.08 or more, 0.09 or more, 0.1 or more, or 0.2 or more, and furthermore can also be 0.4 or less, or 0.3 or less.

The additive B is at least one selected from the group consisting of the compound (II) represented by Formula (II), the compound (III) that is at least one of a monofluorophosphate or a difluorophosphate, the compound (IV) represented by Formula (IV), the compound (V) represented by Formula (V), the compound (VI) represented by Formula (VI), the compound (VII) represented by Formula (VII), and the compound (VIII) represented by Formula (VIII), and such each compound serving as the additive B is described below.

### (Compound (II))

The compound (II) is a compound represented by the following Formula (II).

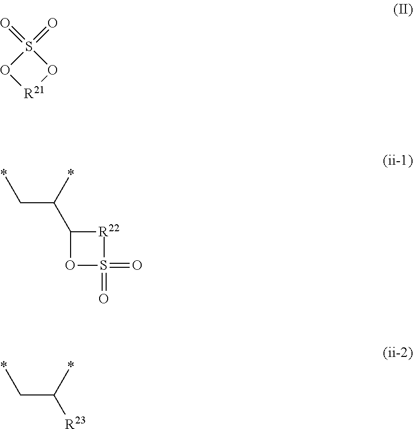

In Formula (II),
R²¹ represents a “group represented by Formula (ii-1)”, a “group represented by Formula (ii-2)”, or a “divalent hydrocarbon group having from 3 to 6 carbon atoms”,
* represents a “binding position”,
in Formula (ii-1), R²² represents an “oxymethylene group (—OCH₂—)”, an “oxyethylene group (—OCH₂CH₂—)”, an “oxa group (—O—)”, or a “divalent hydrocarbon group having from 1 to 6 carbon atoms”, and
in Formula (ii-2), R²³ represents a “hydrocarbon group having from 1 to 8 carbon atoms”.

In Formula (ii-1) and Formula (ii-2), * represents a “binding position”, and it is meant that each binding to two oxygen atoms in Formula (II) at the * site is formed and, in a case in which R²¹ is a “group represented by Formula (ii-1)” or a “group represented by Formula (ii-2)”, a five-membered ring ( . . . S(═O)₂—O—CH₂—CHR—O . . . ) of ethylene sulfate is formed. The “divalent hydrocarbon group” means a hydrocarbon group having two binding positions, is not limited to an aliphatic hydrocarbon group having a linear structure as in the above-mentioned “hydrocarbon group”, and means that it may be a group having at least one structure selected from the group consisting of a branched structure, a cyclic structure, or a carbon-carbon unsaturated bond structure (carbon-carbon double bond structure or a carbon-carbon triple bond structure), or may be an aromatic hydrocarbon group. In other words, all of an alkylene group, an alkenylene group, an alkynylene group, an arylene group, and the like are encompassed in the “divalent hydrocarbon group”. R² being an “oxymethylene group (—OCH₂—)” means that an oxa group (—O—) of an oxymethylene group is bound with a sulfonyl group (>S(═O)₂) to form a five-membered ring ( . . . S(═O)₂—O—CH₂—CHR—O . . . ) of a sulfate ester, R² being an “oxyethylene group (—OCH₂CH₂—)” means that such binding provides formation of a six-membered ring ( . . . S(═O)₂—O—CH₂—CH₂—CHR—O . . . ) of propene sulfate, and R² being an “oxa group (—O—)” means that such binding provides formation four-membered ring ( . . . S(═O)₂—O—CHR—O . . . ) of a methylene sulfate.

In a case in which R²¹ is a “divalent hydrocarbon group having from 3 to 6 carbon atoms”, the number of carbon atoms in the hydrocarbon group is preferably 5 or less, more preferably 4 or less.

In a case in which R²² is a “divalent hydrocarbon group having from 1 to 6 carbon atoms”, the number of carbon atoms in the hydrocarbon group is preferably 5 or less, more preferably 4 or less, still more preferably 3 or less, particularly preferably 2 or less.

R²³ is a “hydrocarbon group having from 1 to 8 carbon atoms”, and the number of carbon atoms in the hydrocarbon group is preferably 6 or less, more preferably 5 or less, still more preferably 4 or less, particularly preferably 3 or less.

R²¹ is preferably a group represented by Formula (ii-1), a group represented by Formula (ii-2), an alkylene group having from 3 to 6 carbon atoms, or an alkenylene group having from 3 to 6 carbon atoms, still more preferably a group represented by Formula (ii-1), a group represented by Formula (ii-2), or a n-propylene group (—CH₂CH₂CH₂—), particularly preferably a group represented by Formula (ii-1).

R²² is preferably an oxymethylene group (—OCH₂—), an oxyethylene group (—OCH₂CH₂—), an oxa group (—O—), an alkylene group having from 1 to 6 carbon atoms, or an alkenylene group having from 1 to 6 carbon atoms, still more preferably an oxymethylene group (—OCH₂—), an oxyethylene group (—OCH₂CH₂—), an oxa group (—O—), a methylene group (—CH₂—), an ethylene group (—CH₂CH₂—), or a n-propylene group (—CH₂CH₂CH₂—), particularly preferably an oxymethylene group (—OCH₂—).

R²³ is preferably an alkyl group having from 1 to 8 carbon atoms, an alkenyl group having from 2 to 8 carbon atoms, an alkynyl group having from 2 to 8 carbon atoms, or an aryl group having from 6 to 8 carbon atoms, still more preferably a methyl group (—CH), an ethyl group (—CH₂CH₃), a vinyl group (—CH═CH₂), a n-propyl group (—CH₂CH₂CH₃), a n-butyl group (—CH₂CH₂CH₂CH₃), or a phenyl group (—C₆H₅), particularly preferably a methyl group (—CH₃), an ethyl group (—CH₂CH₃—), a vinyl group (—CH═CH₂), or a n-propyl group (—CH₂CH₂CH₃).

Specific examples of the compound (II) include the following compound (II-1) to the following compound (II-3).

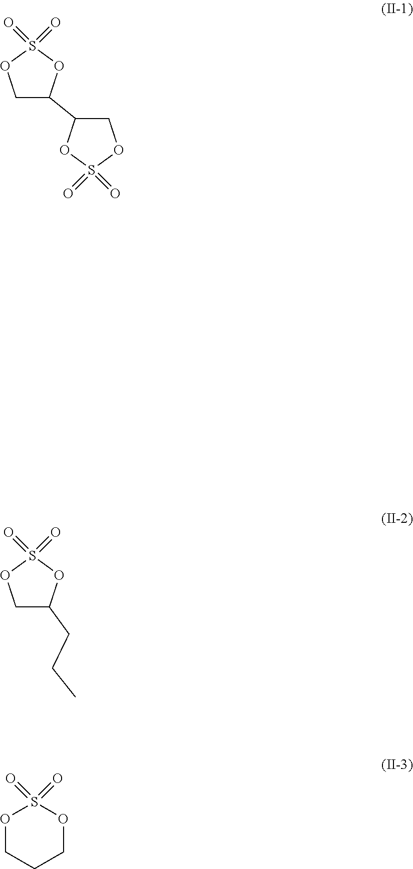

In a case in which the non-aqueous electrolytic solution of the disclosure contains the compound (II) as the additive B, the content of the compound (II) with respect to the total amount of the non-aqueous electrolytic solution is usually from 0.01% by mass to 5.0% by mass from the viewpoint of the effects by the non-aqueous electrolytic solution of the disclosure can be more effectively obtained, and is preferably 0.03% by mass or more, more preferably 0.05% by mass or more, still more preferably 0.1% by mass or more, particularly preferably 0.3% by mass or more, and preferably 3.0% by mass or less, more preferably 2.0% by mass or less, still more preferably 1.0% by mass or less, particularly preferably 0.9% by mass or less. The content can also be 0.8% by mass or less, or 0.6% by mass or less.

In a case in which the non-aqueous electrolytic solution of the disclosure contains the compound (II) as the additive B, the content mass ratio of the additive A to the compound (II) (namely, the ratio between the content mass of the additive A and the content mass of the compound (II), which is the ratio obtained by dividing the content mass of the additive A by the content mass of the compound (II); hereinafter, also referred to as “content mass ratio [additive A/compound (II)]”) is usually from 0.05 to 0.5 from the viewpoint of the effects by the non-aqueous electrolytic solution of the disclosure can be more effectively obtained, and is preferably 0.06 or more, preferably 0.45 or less. The content can also be 0.08 or more, 0.09 or more, 0.1 or more, or 0.2 or more, and furthermore can also be 0.4 or less, or 0.3 or less.

### (Compound (III))

The compound (III) is at least one of a monofluorophosphate or a difluorophosphate.

The cation in the monofluorophosphate and the difluorophosphate is preferably a lithium ion (Li⁺), a sodium ion (Na⁺), or a potassium ion (K⁺), particularly preferably a lithium ion (Li⁺).

Specific examples of the compound (III) include the following compound (III-1) and the following compound (III-2).

The following compound (III-1) is lithium difluorophosphate and the following compound (III-2) is lithium monofluorophosphate.

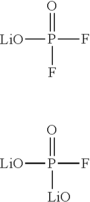

The compound (III) may correspond to only one of the monofluorophosphate and the difluorophosphate, or may correspond to both the monofluorophosphate and the difluorophosphate.

In a case in which the non-aqueous electrolytic solution of the disclosure contains the compound (III) as the additive B, the content of the compound (III) with respect to the total amount of the non-aqueous electrolytic solution is usually from 0.01% by mass to 5.0% by mass from the viewpoint of the effects by the non-aqueous electrolytic solution of the disclosure can be more effectively obtained, and is preferably 0.03% by mass or more, more preferably 0.05% by mass or more, still more preferably 0.1% by mass or more, particularly preferably 0.3% by mass or more, and preferably 3.0% by mass or less, more preferably 2.0% by mass or less, still more preferably 1.0% by mass or less, particularly preferably 0.9% by mass or less. The content can also be 0.8% by mass or less, or 0.6% by mass or less.

In a case in which the non-aqueous electrolytic solution of the disclosure contains the compound (III) as the additive B, the content mass ratio of the additive A to the compound (III) (namely, the ratio between the content mass of the additive A and the content mass of the compound (III), which is the ratio obtained by dividing the content mass of the additive A by the content mass of the compound (III); hereinafter, also referred to as “content mass ratio [additive A/compound (III)|”) is usually from 0.05 to 0.5 from the viewpoint of the effects by the non-aqueous electrolytic solution of the disclosure can be more effectively obtained, and is preferably 0.06 or more, preferably 0.45 or less. The content can also be 0.08 or more, 0.09 or more, 0.1 or more, or 0.2 or more, and furthermore can also be 0.4 or less, or 0.3 or less.

### (Compound (IV))

The compound (IV) is a compound represented by the following Formula (IV).

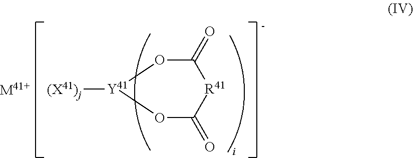

In Formula (IV),
M⁴¹⁺ represents an “alkali metal ion”,
each X⁴¹ independently represents a “fluoro group (—F)”, a “chloro group (—Cl)”, a “bromo group (—Br)”, or an “iodo group (—I)”,
Y⁴¹ represents a “boron atom” or a “phosphorus atom”,
each R⁴¹ independently represents a “single bond (—)” or a “divalent hydrocarbon group having from 1 to 6 carbon atoms, optionally containing, as a substituent, at least one group selected from the group consisting of a fluoro group (—F), a chloro group (—Cl), a bromo group (—Br), and an iodo group (—I)”,
i represents 1 or 2 in a case in which the Y⁴¹ is a boron atom, or represents an integer from 1 to 3 in a case in which the Y⁴¹ is a phosphorus atom, and
j represents 0 or 2 in a case in which the Y⁴¹ is a boron atom, or represents 0, 2, or 4 in a case in which the Y⁴¹ is a phosphorus atom.

While R⁴¹ may be a “single bond (—)”, R⁴¹ being a “single bond (—)” means that two carbonyl groups (>C═O) adjacent to R⁴¹ are directly bound, namely, means that an oxalate ion (C₂O₄²) serves as a polydentate ligand to form an oxalate complex. The “divalent hydrocarbon group” has the same meaning as mentioned above. The phrase “optionally containing, as a substituent, at least one group selected from the group consisting of a fluoro group (—F), a chloro group (—Cl), a bromo group (—Br), and an iodo group (—I)” means that not only a hydrocarbon group not containing a fluoro group (—F) or the like as a substituent is included, but also a hydrocarbon group is included in which some hydrogen atoms of such a hydrocarbon group are each substituted with any of a fluoro group (—F), a chloro group (—Cl), a bromo group (—Br), and an iodo group, provided that the respective numbers of fluoro groups (—F), chloro groups (—Cl), bromo groups (—Br), and iodo groups (—I), and any combination thereof are not particularly limited.

In a case in which R⁴¹ is a “divalent hydrocarbon group having from 1 to 6 carbon atoms, optionally containing, as a substituent, at least one group selected from the group consisting of a fluoro group (—F), a chloro group (—Cl), a bromo group (—Br), and an iodo group (—I)”, the number of carbon atoms in such a hydrocarbon group is preferably 5 or less, more preferably 4 or less, still more preferably 3 or less.

M⁴¹ is preferably a lithium ion (Li⁺), a sodium ion (Na⁺), or a potassium ion (K⁺), particularly preferably a lithium ion (Li⁺).

X⁴¹ is preferably a fluoro group (—F) or a chloro group (—Cl), particularly preferably a fluoro group (—F).

Y⁴¹ represents a boron atom or a phosphorus atom, i represents 1 or 2 in a case in which Y⁴¹ is a boron atom, or represents an integer from 1 to 3 in a case in which Y⁴¹ is a phosphorus atom, and j represents 0 or 2 in a case in which Y⁴¹ is a boron atom, or represents 0, 2, or 4 in a case in which Y⁴¹ is a phosphorus atom, wherein, in a case in which Y⁴¹ is a boron atom, a combination of i and j is a combination of i=1 and j=2, or a combination of i=2 and j=0, and in a case in which Y⁴¹ is a phosphorus atom, a combination of i and j is a combination of i=1 and j=4, a combination of i=2 and j=2, or a combination of i=3 and j=0.

R⁴¹ is preferably a single bond (—), an alkylene group having from 1 to 6 carbon atoms, an alkenylene group having from 2 to 6 carbon atoms, an alkenylene group having from 2 to 6 carbon atoms, an alkylene group having from 1 to 6 carbon atoms, containing a fluoro group (—F), an alkenylene group having from 2 to 6 carbon atoms, containing a fluoro group (—F), or an alkynylene group having from 2 to 6 carbon atoms, containing a fluoro group (—F), preferably a single bond (—), a methylene group (—CH₂—), an ethylene group (—CH₂CH₂—), or a n-propylene group (—CH₂CH₂CH₂—), particularly preferably a single bond (—).

Specific examples of the compound (IV) include the following compound (IV-1) to the following compound (IV-4).

The compound (IV-1) is lithium bis(oxalato)borate (LiBOB), the compound (IV-2) is lithium difluorooxalatoborate (LiDFOB), the compound (IV-3) is lithium tetrafluorooxalatophosphate (LiTFOP), and the compound (IV-4) is lithium difluorobis(oxalato)phosphate (LiDFBOP).

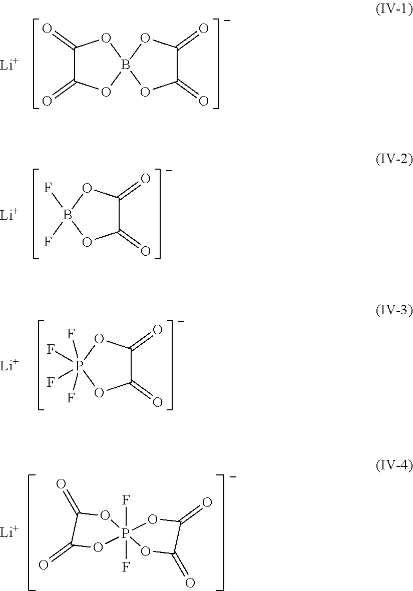

In a case in which the non-aqueous electrolytic solution of the disclosure contains the compound (IV) as the additive B, the content of the compound (IV) with respect to the total amount of the non-aqueous electrolytic solution is usually from 0.01% by mass to 5.0% by mass from the viewpoint of the effects by the non-aqueous electrolytic solution of the disclosure can be more effectively obtained, and is preferably 0.03% by mass or more, more preferably 0.05% by mass or more, still more preferably 0.1% by mass or more, particularly preferably 0.3% by mass or more, and preferably 3.0% by mass or less, more preferably 2.0% by mass or less, still more preferably 1.0% by mass or less, particularly preferably 0.9% by mass or less. The content can also be 0.8% by mass or less, or 0.6% by mass or less.

In a case in which the non-aqueous electrolytic solution of the disclosure contains the compound (IV) as the additive B, the content mass ratio of the additive A to the compound (IV) (namely, the ratio between the content mass of the additive A and the content mass of the compound (IV), which is the ratio obtained by dividing the content mass of the additive A by the content mass of the compound (IV); hereinafter, also referred to as “content mass ratio [additive A/compound (IV)]”) is usually from 0.05 to 0.5 from the viewpoint of the effects by the non-aqueous electrolytic solution of the disclosure can be more effectively obtained, and is preferably 0.06 or more, and preferably 0.45 or less. The content can also be 0.08 or more, 0.09 or more, 0.1 or more, or 0.2 or more, and furthermore can also be 0.4 or less, or 0.3 or less.

### (Compound (V))

The compound (V) is a compound represented by the following Formula (V).

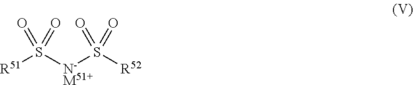

In Formula (V),
M⁵¹⁺ represents an “alkali metal ion”,
each of R¹¹ and R⁵² independently represents a “fluoro group (—F)”, a “hydrocarbon group having from 1 to 3 carbon atoms, optionally containing a fluoro group as a substituent”, or a “fluorocarbon group having from 1 to 3 carbon atoms”.

The “hydrocarbon group” and the “fluorocarbon group” have the same meanings as mentioned above.

M⁵¹ is preferably a lithium ion (Li⁺), a sodium ion (Na⁺), or a potassium ion (K⁺), particularly preferably a lithium ion (Li⁺).

R⁵¹ and R⁵² are each preferably a fluoro group (—F), an alkyl group having from 1 to 3 carbon atoms, an alkyl group having from 1 to 3 carbon atoms, containing a fluoro group (—F), or a perfluoroalkyl group having from 1 to 3 carbon atoms, particularly preferably a fluoro group (—F), a monofluoromethyl group (—CH₂F), a difluoromethyl group (—CHF₂), a trifluoromethyl group (—CF₃), a pentafluoroethyl group (—CF₂CF₃), or a heptafluoropropyl group (—CF₂CF₂CF₃).

Specific examples of the compound (V) include the following compound (V-1) and the following compound (V-2).

The compound (V-1) is lithium bis(fluorosulfonyl)imide and the compound (V-2) is lithium bis(trifluoromethanesulfonyl)imide. Herein, lithium bis(fluorosulfonyl)imide, lithium bis(trifluoromethanesulfonyl)imide, or the like is also used as an electrolyte described below (more specifically, corresponding to an organic acid anionic salt of a fluorine-containing lithium salt described below), and thus even a non-aqueous electrolytic solution intended to be used as an electrolyte is meant to correspond to the non-aqueous electrolytic solution of the disclosure as long as other matters (elements) used to specify the invention, according to the disclosure, are satisfied.

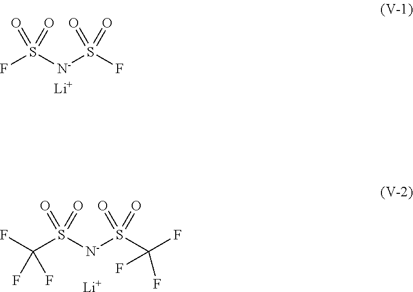 [SMILES: O=S(=O)(F)[N-]S(=O)(=O)F ; [Li+] ; O=S(=O)([N-]S(=O)(=O)C(F)(F)F)C(F)(F)F ; [Li+]]

In a case in which the non-aqueous electrolytic solution of the disclosure contains the compound (V) as the additive B, the content of the compound (V) is usually from 0.01% by mass to 5.0% by mass with respect to the total amount of the non-aqueous electrolytic solution from the viewpoint of the effects by the non-aqueous electrolytic solution of the disclosure can be more effectively obtained, and is preferably 0.03% by mass or more, more preferably 0.05% by mass or more, still more preferably 0.1% by mass or more, particularly preferably 0.3% by mass or more, and preferably 3.0% by mass or less, more preferably 2.0% by mass or less, still more preferably 1.0% by mass or less, particularly preferably 0.9% by mass or less. The content can also be 0.8% by mass or less, or 0.6% by mass or less. In this regard, in a case in which the compound (V) is used as an electrolyte described below, the content of the compound (V) with respect to the total amount of the non-aqueous electrolytic solution is preferably 0.05 mol/L (M (Molar)) or more, more preferably 0.1 mol/L (M), still more preferably 0.3 mol/L (M), particularly preferably 0.5 mol/L (M) or more, and preferably 6 mol/L (M) or less, more preferably 3 mol/L (M) or less, still more preferably 1 mol/L (M) or less, particularly preferably 0.7 mol/L (M) or less.

In a case in which the non-aqueous electrolytic solution of the disclosure contains the compound (V) as the additive B, the content mass ratio of the additive A to the compound (V) (namely, the ratio between the content mass of the additive A and the content mass of the compound (V), which is the ratio obtained by dividing the content mass of the additive A by the content mass of the compound (V); hereinafter, also referred to as “content mass ratio [additive A/compound (V)]”) is usually from 0.05 to 0.5 from the viewpoint of the effects by the non-aqueous electrolytic solution of the disclosure can be more effectively obtained, and is preferably 0.06 or more, and preferably 0.45 or less. The content can also be 0.08 or more, 0.09 or more, 0.1 or more, or 0.2 or more, and furthermore can also be 0.4 or less, or 0.3 or less.

### (Compound (VI))

The compound (VI) is a compound represented by the following Formula (VI).

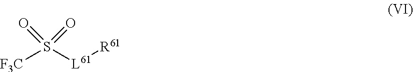

In Formula (VI),
R⁶¹ represents a “hydrocarbon group having from 1 to 8 carbon atoms, containing, as a substituent, at least one group selected from the group consisting of a fluoro group (—F), a chloro group (—Cl), a bromo group (—Br), an iodo group (—I), an oxa group (—O—), a thio group (—S—), a secondary amino group (—NH—), a tertiary amino group (—N<), a carbonyl group (>C═O), and a sulfonyl group (>S(═O)₂)”, and
L⁶¹ represents a “single bond (—)” or an “oxa group (—O—)”.

The “hydrocarbon group” has the same meaning as mentioned above. The “optionally containing, as a substituent, at least one group selected from the group consisting of a fluoro group (—F), a chloro group (—Cl), a bromo group (—Br), an iodo group (—I), an oxa group (—O—), a thio group (—S—), a secondary amino group (—NH—), a tertiary amino group (—N<), a carbonyl group (>C═O), and a sulfonyl group (>S(═O)₂)” means that not only a hydrocarbon group not containing a fluoro group (—F) or the like as a substituent is encompassed, but also a hydrocarbon group in which some hydrogen atoms are each substituted with any of a fluoro group (—F), a chloro group (—Cl), a bromo group (—Br), and an iodo group, and furthermore a hydrocarbon group in which some carbon atoms of the hydrocarbon group are each substituted with any of an oxa group (—O—), a thio group (—S—), a secondary amino group (—NH—), a tertiary amino group (—N<), a carbonyl group (>C═O), and a sulfonyl group (>S(═O)₂) are encompassed, provided that the respective numbers of fluoro groups (—F), chloro groups (—Cl), bromo groups (—Br), iodo groups (—I), oxa groups (—O—), thio groups (—S—), secondary amino groups (—NH—), tertiary amino groups (—N<), carbonyl groups (>C═O), and sulfonyl groups (>S(═O)₂), and any combination thereof are not particularly limited.

R⁶¹ is a “hydrocarbon group having from 1 to 8 carbon atoms, optionally containing, as a substituent, at least one group selected from the group consisting of a fluoro group (—F), a chloro group (—Cl), a bromo group (—Br), an iodo group (—I), an oxa group (—O—), a thio group (—S—), a secondary amino group (—NH—), a tertiary amino group (—N<), a carbonyl group (>C═O), and a sulfonyl group (>S(═O)₂)”, the number of carbon atoms in the hydrocarbon group is preferably 6 or less, more preferably 5 or less, still more preferably 4 or less, particularly preferably 3 or less.

R⁶¹ is preferably an alkyl group having from 1 to 8 carbon atoms, an alkenyl group having from 2 to 8 carbon atoms, an alkynyl group having from 2 to 8 carbon atoms, an aryl group having from 6 to 8 carbon atoms, preferably a methyl group (—CH₃), an ethyl group (—CH₂CH₃), a vinyl group (—CH═CH₂), a n-propyl group (—CH₂CH₂CH₃), or a n-butyl group (—CH₂CH₂CH₂CH₃), particularly preferably a methyl group (—CH₃) or an ethyl group (—CH₂CH₃).

L⁶¹ is particularly preferably a single bond (—).

Specific examples of the compound (VI) include the following compound (VI-1) and the following compound (VI-2).

The compound (VI-1) is trifluoromethylmethylsulfone, and the compound (VI-2) is trifluoromethylethylsulfone.

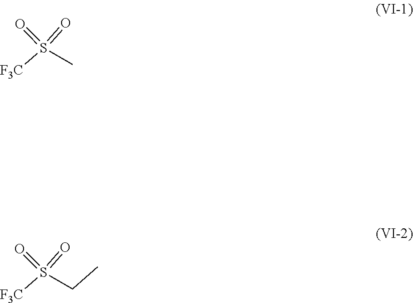

In a case in which the non-aqueous electrolytic solution of the disclosure contains the compound (VI) as the additive B, the content of the compound (VI) with respect to the total amount of the non-aqueous electrolytic solution is usually from 0.01% by mass to 5.0% by mass from the viewpoint of the effects by the non-aqueous electrolytic solution of the disclosure can be more effectively obtained, and is preferably 0.03% by mass or more, more preferably 0.05% by mass or more, still more preferably 0.1% by mass or more, particularly preferably 0.3% by mass or more, and preferably 3.0% by mass or less, more preferably 2.0% by mass or less, still more preferably 1.0% by mass or less, particularly preferably 0.9% by mass or less. The content can also be 0.8% by mass or less, or 0.6% by mass or less.

In a case in which the non-aqueous electrolytic solution of the disclosure contains the compound (VI) as the additive B, the content mass ratio of the additive A to the compound (VI) (namely, the ratio between the content mass of the additive A and the content mass of the compound (VI), which is the ratio obtained by dividing the content mass of the additive A by the content mass of the compound (VI); hereinafter, also referred to as “content mass ratio [additive A/compound (VI)]”) is usually from 0.05 to 0.5 from the viewpoint of the effects by the non-aqueous electrolytic solution of the disclosure can be more effectively obtained, and is preferably 0.06 or more, and preferably 0.45 or less. The content can also be 0.08 or more, 0.09 or more, 0.1 or more, or 0.2 or more, and furthermore can also be 0.4 or less, or 0.3 or less.

### (Compound (VII))

The compound (VII) is a compound represented by the following Formula (VII).

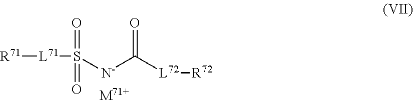

In Formula (VII),
M⁷¹⁺ represents an “alkali metal ion”,
each of R⁷¹ and R⁷² independently represents a “fluoro group (—F)”, a “chloro group (—Cl)”, a “bromo group (—Br)”, an “iodo group (—I)”, a “hydrocarbon group having from 1 to 12 carbon atoms, optionally containing, as a substituent, at least one selected from the group consisting of a fluoro group (—F), a chloro group (—Cl), a bromo group (—Br), an iodo group (—I), and an oxa group (—O—)”, or a “fluorocarbon group having from 1 to 8 carbon atoms”, and
each of L⁷¹ and L⁷² represent a “single bond (—)” or an “oxa group (—O—)”, and at least one of L⁷¹ or L⁷² is an oxa group (—O—).

The “hydrocarbon group”, the “fluorocarbon group”, the “single bond (—)”, and the “oxa group (—O—)” have the same meanings as mentioned above. The “optionally containing, as a substituent, at least one selected from the group consisting of a fluoro group (—F), a chloro group (—Cl), a bromo group (—Br), an iodo group (—I), and an oxa group (—O—)” means that not only a hydrocarbon group not containing a fluoro group (—F) or the like as a substituent is encompassed, but also a hydrocarbon group in which some hydrogen atoms of the hydrocarbon group are each substituted with any of a fluoro group (—F), a chloro group (—Cl), a bromo group (—Br), and an iodo group, and furthermore a hydrocarbon group in which carbon atoms of the hydrocarbon group are each substituted with an oxa group (—O—) are encompassed, provided that the respective numbers of fluoro groups (—F), chloro groups (—Cl), bromo groups (—Br), iodo groups (—I), and oxa groups (—O—), and any combination thereof are not particularly limited. While each of L⁷¹ and L⁷² represents a “single bond (—)” or an “oxa group (—O—)”, L⁷¹ being a “single bond (—)” means that R⁷¹ adjacent to L⁷¹ and a sulfonyl group (>S(═O)₂) are directly bound, and L⁷¹ being an “oxa group (—O—)” means that a structure of R^{7′}—O—S(═O)₂— is formed. Similarly, L⁷² being a “single bond (—)” means that R⁷² adjacent to L⁷² and a carbonyl group (>C═O) are directly bound, and L⁷² being an “oxa group (—O—)” means that a structure of R⁷²—O—C(═O)— is formed.

M⁷¹ is preferably a lithium ion (Li⁺), a sodium ion (Na⁺), or a potassium ion (K⁺), particularly preferably a lithium ion (Li⁺).

R⁷¹ is preferably a fluoro group (—F), an alkyl group having from 1 to 12 carbon atoms, alkenyl group having from 2 to 12 carbon atoms, an alkynyl group having from 2 to 12 carbon atoms, an aryl group having from 6 to 12 carbon atoms, an alkyl group having from 1 to 12 carbon atoms, containing a fluoro group (—F), an alkenyl group having from 2 to 12 carbon atoms, containing a fluoro group (—F), an alkynyl group having from 2 to 12 carbon atoms, containing a fluoro group (—F), an aryl group having from 6 to 12 carbon atoms, containing a fluoro group (—F), an alkyl group having from 1 to 12 carbon atoms, containing an oxa group (—O—), an alkenyl group having from 2 to 12 carbon atoms, containing an oxa group (—O—), an alkynyl group having from 2 to 12 carbon atoms, containing an oxa group (—O—), an aryl group having from 6 to 12 carbon atoms, containing an oxa group (—O—), an alkyl group having from 1 to 12 carbon atoms, containing a fluoro group (—F) and an oxa group (—O—), an alkenyl group having from 2 to 12 carbon atoms, containing a fluoro group (—F) and an oxa group (—O—), an alkynyl group having from 2 to 12 carbon atoms, containing a fluoro group (—F) and an oxa group (—O—), or an aryl group having from 6 to 12 carbon atoms containing a fluoro group (—F) and an oxa group (—O—), preferably a fluoro group (—F), a methyl group (—CH₃), a trifluoromethyl group (—CF₃), an ethyl group (—CH₂CH₃), a 2,2,2-trifluoroethyl group (—CH₂CF₃), a phenyl group (—C₆H₅), a p-methylphenyl group (—C₆H₄CH₃), a p-trifluoromethylphenyl group (—C₆H₄CF₃), or a p-trifluoromethoxyphenyl group (—C₆H₄OCF₃), still more preferably a fluoro group (—F) or a trifluoromethyl group (—CF₃), particularly preferably a fluoro group (—F).

R⁷² is preferably an alkyl group having from 1 to 12 carbon atoms, an alkenyl group having from 2 to 12 carbon atoms, an alkynyl group having from 2 to 12 carbon atoms, an aryl group having from 6 to 12 carbon atoms, an alkyl group having from 1 to 12 carbon atoms, containing a fluoro group (—F), an alkenyl group having from 2 to 12 carbon atoms, containing a fluoro group (—F), an alkynyl group having from 2 to 12 carbon atoms, containing a fluoro group (—F), an aryl group having from 6 to 12 carbon atoms, containing a fluoro group (—F), an alkyl group having from 1 to 12 carbon atoms, containing an oxa group (—O—), an alkenyl group having from 2 to 12 carbon atoms, containing an oxa group (—O—), an alkynyl group having from 2 to 12 carbon atoms, containing an oxa group (—O—), an aryl group having from 6 to 12 carbon atoms, containing an oxa group (—O—), an alkyl group having from 1 to 12 carbon atoms, containing a fluoro group (—F) and an oxa group (—O—), an alkenyl group having from 2 to 12 carbon atoms, containing a fluoro group (—F) and an oxa group (—O—), an alkynyl group having from 2 to 12 carbon atoms, containing a fluoro group (—F) and an oxa group (—O—), or an aryl group having from 6 to 12 carbon atoms, containing a fluoro group (—F) and an oxa group (—O—), preferably a methyl group (—CH₃), a trifluoromethyl group (—CF₃), an ethyl group (—CH₂CH₃), a n-propyl group (—CH₂CH₂CH₃), an i-propyl group (—CH(CH₃)CH₃), a n-butyl group (—CH₂CH₂CH₂CH₃), a t-butyl group (—C(CH₃)₃), a 2,2,2-trifluoroethyl group (—CH₂CF₃), a phenyl group (—C₆H₅), a methylphenyl group (—CH₂C₆H₅), a p-methylphenyl group (—C₆H₄CH₃), a p-trifluoromethylphenyl group (—C₆H₄CF₃), a p-methoxyphenyl group (—C₆H₄OCH₃), a p-trifluoromethoxyphenyl group (—C₆H₄OCF₃), a p-fluorophenyl group (—C₆H₄F), or a p-chlorophenyl group (—C₆H₄Cl), particularly preferably a methyl group (—CH₃), a trifluoromethyl group (—CF₃), an ethyl group (—CH₂CH₃), a n-propyl group (—CH₂CH₂CH₃), or an i-propyl group (—CH(CH₃)CH₃).

While each of L⁷¹ and L⁷² represents a “single bond (—)” or an “oxa group (—O—)” and at least one of L⁷¹ or L⁷² is an oxa group (—O—), a combination is particularly preferred in which L⁷¹ is a single bond and L⁷² is an oxa group (—O—).

Specific examples of the compound (VII) include the following compound (VII-1) and the following compound (VII-2).

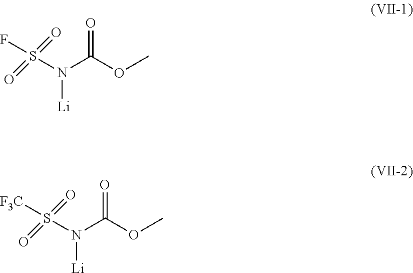

In a case in which the non-aqueous electrolytic solution of the disclosure contains the compound (VII) as the additive B, the content of the compound (VII) with respect to the total amount of the non-aqueous electrolytic solution is usually from 0.01% by mass to 5.0% by mass from the viewpoint of the effects by the non-aqueous electrolytic solution of the disclosure can be more effectively obtained, and is preferably 0.03% by mass or more, more preferably 0.05% by mass or more, still more preferably 0.1% by mass or more, particularly preferably 0.3% by mass or more, and preferably 3.0% by mass or less, more preferably 2.0% by mass or less, still more preferably 1.0% by mass or less, particularly preferably 0.9% by mass or less. The content can also be 0.8% by mass or less, or 0.6% by mass or less.

In a case in which the non-aqueous electrolytic solution of the disclosure contains the compound (VII) as the additive B, the content of the compound (VII), the content mass ratio of the additive A to the compound (VII)(namely, the ratio between the content mass of the additive A and the content mass of the compound (VII), which is the ratio obtained by dividing the content mass of the additive A by the content mass of the compound (VI); hereinafter, also referred to as “content mass ratio [additive A/compound (VII)]”) is usually from 0.05 to 0.5 from the viewpoint of the effects by the non-aqueous electrolytic solution of the disclosure can be more effectively obtained, and is preferably 0.06 or more, and preferably 0.45 or less. The content can also be 0.08 or more, 0.09 or more, 0.1 or more, or 0.2 or more, and furthermore can also be 0.4 or less, or 0.3 or less.

### (Compound (VIII))

The compound (VIII) is a compound represented by the following Formula (VIII).

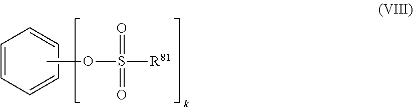

In Formula (VIII),
each R⁸¹ independently represents a “fluoro group (—F)”, a “chloro group (—Cl)”, a “bromo group (—Br)”, or an “iodo group (—I)”, and
k represents an integer from 1 to 6.

R⁸¹ is particularly preferably a fluoro group (—F).
k represents an integer from 1 to 6, and k is preferably 1, 2, or 3, still more preferably 2 or 3, particularly preferably 3.

Specific examples of the compound (VIII) include the following compound (VIII-1).

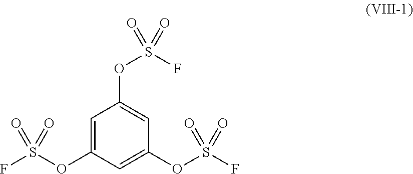 [SMILES: O=S(=O)(F)Oc1cc(OS(=O)(=O)F)cc(OS(=O)(=O)F)c1]

In a case in which the non-aqueous electrolytic solution of the disclosure contains the compound (VIII) as the additive B, the content of the compound (VIII) with respect to the total amount of the non-aqueous electrolytic solution is usually from 0.01% by mass to 5.0% by mass from the viewpoint of the effects by the non-aqueous electrolytic solution of the disclosure can be more effectively obtained, and is preferably 0.03% by mass or more, more preferably 0.05% by mass or more, still more preferably 0.1% by mass or more, particularly preferably 0.3% by mass or more, and preferably 3.0% by mass or less, more preferably 2.0% by mass or less, still more preferably 1.0% by mass or less, particularly preferably 0.9% by mass or less. The content can also be 0.8% by mass or less, or 0.6% by mass or less.

In a case in which the non-aqueous electrolytic solution of the disclosure contains the compound (VIII) as the additive B, the content mass ratio of the additive A to the compound (VIII) (namely, the ratio between the content mass of the additive A and the content mass of the compound (VIII), which is the ratio obtained by dividing the content mass of the additive A by the content mass of the compound (VI); hereinafter, also referred to as “content mass ratio [additive A/compound (VIII)]”) is usually from 0.05 to 0.5 from the viewpoint of the effects by the non-aqueous electrolytic solution of the disclosure can be more effectively obtained, and is preferably 0.06 or more, and preferably 0.45 or less. The content can also be 0.08 or more, 0.09 or more, 0.1 or more, or 0.2 or more, and furthermore can also be 0.4 or less, or 0.3 or less.

### <Non-Aqueous Solvent>

The non-aqueous electrolytic solution generally contains a non-aqueous solvent. The non-aqueous solvent can be appropriately selected from various known solvents. The non-aqueous solvent may be adopted singly, or in combination of two or more kinds thereof.

Examples of the non-aqueous solvent include a cyclic carbonate compound, a fluorine-containing cyclic carbonate compound, a linear carbonate compound, a fluorine-containing linear carbonate compound, an aliphatic carboxylate ester compound, a fluorine-containing aliphatic carboxylate ester compound, a y-lactone compound, a fluorine-containing y-lactone compound, a cyclic ether compound, a fluorine-containing cyclic ether compound, a linear ether compound, a fluorine-containing linear ether compound, a nitrile compound, an amide compound, a lactam compound, nitromethane, nitroethane, sulfolane, trimethyl phosphate, dimethyl sulfoxide, or dimethyl sulfoxide/phosphate.

Examples of the cyclic carbonate compound include ethylene carbonate (EC), propylene carbonate (PC), or butylene carbonate (BC).

Examples of the fluorine-containing cyclic carbonate compound include fluoroethylene carbonate (FEC).

Examples of the linear carbonate compound include dimethyl carbonate (DMC), diethyl carbonate (DEC), ethyl methyl carbonate (EMC), methyl propyl carbonate (MPC), ethyl propyl carbonate (EPC), or dipropyl carbonate (DPC).

Examples of the aliphatic carboxylate ester compound include methyl formate, methyl acetate, methyl propionate, methyl butyrate, methyl isobutyrate, methyl trimethylbutyrate, ethyl formate, ethyl acetate, ethyl propionate, ethyl butyrate, ethyl isobutyrate, or ethyl trimethylbutyrate.

Examples of the γ-lactone compound include γ-butyrolactone or γ-valerolactone.

Examples of the cyclic ether compound include tetrahydrofuran, 2-methyltetrahydrofuran, tetrahydropyran, 1,3-dioxolane, 4-methyl-1,3-dioxolane, 1,3-dioxane, or 1,4-dioxane.

Examples of the linear ether compound include 1,2-ethoxyethane (DEE), ethoxymethoxyethane (EME), diethyl ether, 1,2-dimethoxyethane, or 1,2-dibutoxyethane.

Examples of the nitrile compound include acetonitrile, glutaronitrile, adiponitrile, methoxyacetonitrile, or 3-methoxypropionitrile.

Examples of the amide compound include N,N-dimethylformamide.

Examples of the lactam compound include N-methylpyrrolidinone, N-methyloxazolidinone, or N,N′-dimethylimidazolidinone.

The non-aqueous solvent preferably includes at least one selected from the group consisting of a cyclic carbonate compound, a fluorine-containing cyclic carbonate compound, a linear carbonate compound, and a fluorine-containing linear carbonate compound.

In this case, the total proportion of the cyclic carbonate compound, the fluorine-containing cyclic carbonate compound, the linear carbonate compound, and the fluorine-containing linear carbonate compound, with respect to the total amount of the non-aqueous solvent, is preferably from 50% by mass to 100% by mass, more preferably from 60% by mass to 100% by mass, still more preferably from 80% by mass to 100% by mass.

The non-aqueous solvent preferably includes at least one selected from the group consisting of a cyclic carbonate compound and a linear carbonate compound.

In this case, the total proportion of the cyclic carbonate compound and the linear carbonate compound in the non-aqueous solvent, with respect to the total amount of the non-aqueous solvent, is preferably from 50% by mass to 100% by mass, more preferably from 60% by mass to 100% by mass, still more preferably from 80% by mass to 100% by mass.

The upper limit of the content of the non-aqueous solvent, with respect to the total amount of the non-aqueous electrolytic solution, is preferably 99% by mass, preferably 97% by mass, still more preferably 90% by mass. The lower limit of the content of the non-aqueous solvent, with respect to the total amount of the non-aqueous electrolytic solution, is preferably 60% by mass or more, more preferably 70% by mass or more.

The intrinsic viscosity of the non-aqueous solvent is preferably 10.0 mPa-s or less at 25 °C from the viewpoint of more enhancements in dissociation ability of an electrolyte and the mobility of ion.

### <Electrolyte>

The non-aqueous electrolytic solution generally contains an electrolyte.

The electrolyte preferably contains at least one of a fluorine-containing lithium salt (hereinafter, sometimes referred to as “fluorine-containing lithium salt”.) or a fluorine-free lithium salt.

Examples of the fluorine-containing lithium salt include an inorganic acid anionic salt or an organic acid anionic salt.

Examples of the inorganic acid anionic salt include a lithium hexafluorophosphate (LiPF₆), lithium tetrafluoroborate (LiBF₄), lithium hexafluoroarsenate (LiAsF₆), or lithium hexafluorotantalate (LiTaF₆).

Examples of the organic acid anionic salt include lithium trifluoromethanesulfonate (LiCF₃SO₃).

In particular, the fluorine-containing lithium salt is still more preferably lithium hexafluorophosphate (LiPF₆).

Examples of the fluorine-free lithium salt include lithium perchlorate (LiClO₄), lithium tetrachloroaluminate (LiAlCl₄), or lithium decachlorodecabotaye (Li₂B₁₀Cl₁₀).

In a case in which the electrolyte contains the fluorine-containing lithium salt, the content rate of the fluorine-containing lithium salt with respect to the total amount of the electrolyte is preferably from 50% by mass to 100% by mass, more preferably from 60% by mass to 100% by mass, still more preferably from 80% by mass to 100% by mass.

In a case in which the fluorine-containing lithium salt contains lithium hexafluorophosphate (LiPF₆), the content rate of lithium hexafluorophosphate (LiPF₆) with respect to the total amount of the electrolyte is preferably from 50% by mass to 100% by mass, more preferably from 60% by mass to 100% by mass, still more preferably from 80% by mass to 100% by mass.

In a case in which the non-aqueous electrolytic solution contains the electrolyte, the concentration of the electrolyte in the non-aqueous electrolytic solution is preferably 0.1 mol/L (M (Molar)) or more, more preferably 0.5 mol/L (M) or more, and preferably 6 mol/L (M) or less, more preferably 3 mol/L (M) or less, still more preferably 2 mol/L (M) or less.

In a case in which the non-aqueous electrolytic solution contains lithium hexafluorophosphate (LiPF₆), the concentration of lithium hexafluorophosphate (LiPF₆) in the non-aqueous electrolytic solution is preferably from 0.1 mol/L (M (Molar)) to 3 mol/L (M), more preferably from 0.5 mol/L (M) to 2 mol/L (M).

### [Lithium Secondary Battery Precursor]

The lithium secondary battery precursor of the disclosure includes
a case, and
a positive electrode, a negative electrode, a separator, and an electrolytic solution housed in the case.

Herein,
the positive electrode is a positive electrode capable of occluding and releasing a lithium ion,
the negative electrode is a negative electrode capable of occluding and releasing a lithium ion, and,
the electrolytic solution is the non-aqueous electrolytic solution of the disclosure.

In the disclosure, the lithium secondary battery precursor indicates a lithium secondary battery before application of charge and discharge.

According to the lithium secondary battery precursor of the disclosure, a lithium secondary battery obtained by applying charge and discharge to this lithium secondary battery precursor can be reduced in the rate of increase in normal-temperature resistance during high-temperature storage.

### <Case>

The shape or the like of the case is not particularly limited, and is appropriately selected depending on the application or the like of the lithium secondary battery precursor of the disclosure.

Examples of the case include a case including a laminate film, or a case including a battery can and a battery can lid.

### <Positive Electrode>

The positive electrode is a positive electrode capable of occluding and releasing a lithium ion.

The positive electrode preferably includes at least one positive electrode active material capable of occluding and releasing a lithium ion.

The positive electrode preferably includes a positive electrode current collector, and a positive electrode mixture layer provided on at least one portion of a surface of the positive electrode current collector.

Examples of the material of the positive electrode current collector include a metal or an alloy.

Specifically, examples of the material of the positive electrode current collector include aluminum, nickel, stainless steel material (SUS), or copper. In particular, aluminum is preferred from the viewpoint of the balance between the height of conductivity and the cost. The “aluminum” here means pure aluminum or an aluminum alloy. The positive electrode current collector is preferably aluminum foil. The material of the aluminum foil is not particularly limited, and examples thereof include an A1085 material or an A3003 material.

The positive electrode mixture layer contains a positive electrode active material and a binder.

The positive electrode active material is not particularly limited as long as it is a substance capable of occluding and releasing a lithium ion, and can be appropriately adjusted depending on the application or the like of the lithium secondary battery precursor.

Examples of the positive electrode active material include a first oxide or a second oxide. The first oxide contains lithium (Li) and nickel (Ni) as constituent metal elements. The second oxide contains Li, Ni, and at least one metal element other than Li and Ni, as constituent metal elements. Examples of such a metal element other than Li and Ni include a transition metal element or a typical metal element. The second oxide preferably contains such a metal element other than Li and Ni at a proportion comparable with that of Ni or less than that of Ni in terms of the number of atoms. Such a metal element other than Li and Ni can be, for example, at least one selected from the group consisting of Co, Mn, Al, Cr, Fe, V, Mg, Ca, Na, Ti, Zr, Nb, Mo, W, Cu, Zn, Ga, In, Sn, La, and Ce. Such a positive electrode active material may be used singly, or in mixture of two or more kinds thereof.

The positive electrode active material preferably includes a lithium-containing composite oxide represented by the following Formula (P1) (hereinafter, sometimes referred to as “NCM”). The lithium-containing composite oxide (P1) has the advantages of being high in energy density per unit volume and also being excellent in heat stability.

LiNiₐCo_{b}Mn_{c}O₂ Formula (P1)

In Formula (P1), each of a, b and c is independently from more than 0 to less than 1, and the total of a, b and c is from 0.99 to 1.00.

Specific examples of NCM include LiNi_{0.33}Co_{0.33}Mn_{0.33}O₂, LiNi_{0.5}Co_{0.3}Mn_{0.2}O₂, LiNi_{0.5}Co_{0.2}Mn_{0.3}O₂, LiNi_{0.6}Co_{0.2}Mn_{0.2}O₂, or LiNi_{0.8}Co_{0.1}Mn_{0.1}O₂.

The positive electrode active material may include a lithium-containing composite oxide represented by the following Formula (P2) (hereinafter, sometimes referred to as “NCA”).

LiₜNi_{1-x-y}CoₓAl_{y}O₂ Formula (P2)

In Formula (P2), t is from 0.95 to 1.15, x is from 0 to 0.3, y is from 0.1 to 0.2, and the total of x and y is less than 0.5.

Specific examples of NCA include LiNi_{0.8}Co_{0.15}Al_{0.05}O₂.

In a case in which the positive electrode in the lithium secondary battery precursor of the disclosure includes the positive electrode current collector, and the positive electrode mixture layer including the positive electrode active material and the binder, the content of the positive electrode active material in the positive electrode mixture layer, with respect to the total amount of the positive electrode mixture layer, is preferably from 10% by mass to 99.9% by mass, more preferably from 30% by mass to 99.9% by mass, still more preferably from 50% by mass to 99% by mass, particularly preferably from 70% by mass to 99% by mass.

Examples of the binder include polyvinyl acetate, polymethyl methacrylate, nitrocellulose, a fluororesin, or a rubber particle. Examples of the fluororesin include polytetrafluoroethylene (PTFE), polyvinylidene fluoride (PVDF), a tetrafluoroethylene-hexafluoropropylene copolymer (FEP), or a vinylidene fluoride-hexafluoropropylene copolymer. Examples of the rubber particle include a styrene-butadiene rubber particle or an acrylonitrile nitrile rubber particle. In particular, a fluororesin is preferred from the viewpoint of enhancing oxidation resistance of the positive electrode mixture layer. The binder can be used singly, or, if necessary, in combination of two or more kinds thereof.

The content of the binder in the positive electrode mixture layer, with respect to the total amount of the positive electrode mixture layer, is preferably from 0.1% by mass to 6% by mass from the viewpoint that both physical properties of the positive electrode mixture layer (for example, electrolytic solution permeability and peeling strength) and battery performance are satisfied. In a case in which the content of the binder is 0.1% by mass or more, adhesiveness of the positive electrode mixture layer to the positive electrode current collector, and mutual binding ability of the positive electrode active material are more enhanced. In a case in which the content of the binder is 6% by mass or less, the amount of the positive electrode active material in the positive electrode mixture layer can be more increased and thus the discharge capacity is more enhanced.

The positive electrode mixture layer preferably includes a conductive aid.

A known conductive aid can be used as the material of the conductive aid. Such a known conductive aid is preferably a carbon material having conductivity. Examples of the carbon material having conductivity include graphite, carbon black, a conductive carbon fiber, or fullerene. Such a carbon material can be used singly, or in combination of two or more kinds thereof. Examples of the conductive carbon fiber include a carbon nanotube, a carbon nanofiber, or a carbon fiber. Examples of the graphite include artificial graphite or natural graphite. Examples of the natural graphite include scale-like graphite, lump graphite, or earthy graphite.

The material of the conductive aid may be a commercially available product. Examples of a commercially available product of carbon black include TOKABLACK #4300, #4400, #4500, #5500, or the like (furnace black, manufactured by Tokai Carbon Co., Ltd.), PRINTEX L or the like (furnace black, manufactured by Degussa AG), RAVEN 7000, 5750, 5250, 5000ULTRAIII, 5000ULTRA, or the like, CONDUCTEX SC ULTRA, CONDUCTEX 975ULTRA, or the like, PURE BLACK100, 115, 205 or the like (furnace black, manufactured by Columbian Chemicals). #2350, #2400B, #2600B, #30050B, #3030B, #3230B, #3350B. #3400B, #5400B or the like (furnace black, manufactured by Mitsubishi Chemical Corporation), MONARCH1400, 1300, 900, VULCANXC-72R, BLACKPEARLS 2000, LITX-50, LITX-200 or the like (furnace black, manufactured by Cabot), ENSACO 250G, ENSACO 260G, ENSACO 350G, Super-P (manufactured by TIMCAL Ltd.), KETJENBLACK EC-300J, EC-600JD (manufactured by Akzo Nobel N.V.), or DENKA BLACK HS-100, FX-35 (acetylene black, manufactured by Denka Co., Ltd.).

The positive electrode mixture layer may include any other component. Examples of such any other component include a thickener, a surfactant, a dispersant, a wetting agent, or a defoamer.

### <Negative Electrode>

The negative electrode is a negative electrode capable of occluding and releasing a lithium ion.

The negative electrode preferably includes at least one negative electrode active material capable of occluding and releasing a lithium ion.

The negative electrode preferably includes a negative electrode current collector, and a negative electrode mixture layer provided on at least one portion of a surface of the negative electrode current collector.

The material of the negative electrode current collector is not particularly limited, any known material can be used, and examples thereof include a metal or an alloy. Specifically, examples of the material of the negative electrode current collector include aluminum, nickel, a stainless steel material (SUS), a nickel-plated steel material, or copper. In particular, the material of the negative electrode current collector is preferably copper from the viewpoint of processability. The negative electrode current collector is preferably copper foil.

The negative electrode mixture layer includes a negative electrode active material and a binder.

The negative electrode active material is not particularly limited as long as it is a substance capable of occluding and releasing a lithium ion. The negative electrode active material is preferably, for example, at least one selected from the group consisting of metal lithium, a lithium-containing alloy, a metal which can be alloyed with lithium, or a lithium alloy, an oxide with which a lithium ion can be doped and de-doped, a transition metal nitride with which a lithium ion can be doped and de-doped, and a carbon material with which a lithium ion can be doped and de-doped. In particular, the negative electrode active material is preferably a carbon material with which a lithium ion can be doped and de-doped (hereinafter, also simply referred to as “carbon material”.).

Examples of the carbon material include carbon black, activated carbon, a graphite material, or an amorphous carbon material. Such a carbon material may be used singly, or in mixture of two or more kinds thereof. The form of the carbon material is not particularly limited, and examples thereof include a fibrous, spherical, potato-shaped, or flake-shaped form.

The particle size of the carbon material is not particularly limited, and is preferably from 5 μm to 50 μm, more preferably from 20 μm to 30 μm.

Examples of the amorphous carbon material include hard carbon, coke, meso-carbon microbeads (MCMB) fired at 1500 °C or less, or meso-phase pitch carbon fiber (MCF).

Examples of the graphite material include natural graphite or artificial graphite. Examples of the artificial graphite include graphitized MCMB or graphitized MCF. The graphite material may include boron. The graphite material may be covered with a metal or amorphous carbon. Examples of the material of the metal with which the graphite material is covered include gold, platinum, silver, copper, or tin. The graphite material may be a mixture of amorphous carbon and graphite.

The negative electrode mixture layer preferably includes a conductive aid. Examples of the conductive aid include the same conductive aid as the conductive aid exemplified as the conductive aid which can be included in the positive electrode mixture layer.

The negative electrode mixture layer may include, in addition to the above components, any other component. Examples of such any other component include a thickener, a surfactant, a dispersant, a wetting agent, or a defoamer.

### <Separator>

Examples of the separator include a porous resin flat plate. Examples of the material of the porous resin flat plate include a resin, or a non-woven fabric including this resin. Examples of the resin include polyethylene (PE), polypropylene (PP), polymethylpentene (PMP), polyester, cellulose, or polyamide.

In particular, the separator is preferably a porous resin sheet of a mono-layered or multi-layered structure. The material of the porous resin sheet mainly includes one, or two or more polyolefin resins. The thickness of the separator is preferably from 5 μm to 30 μm. The separator is preferably placed between the positive electrode and the negative electrode.

### <Specific Examples of Lithium Secondary Battery Precursor>

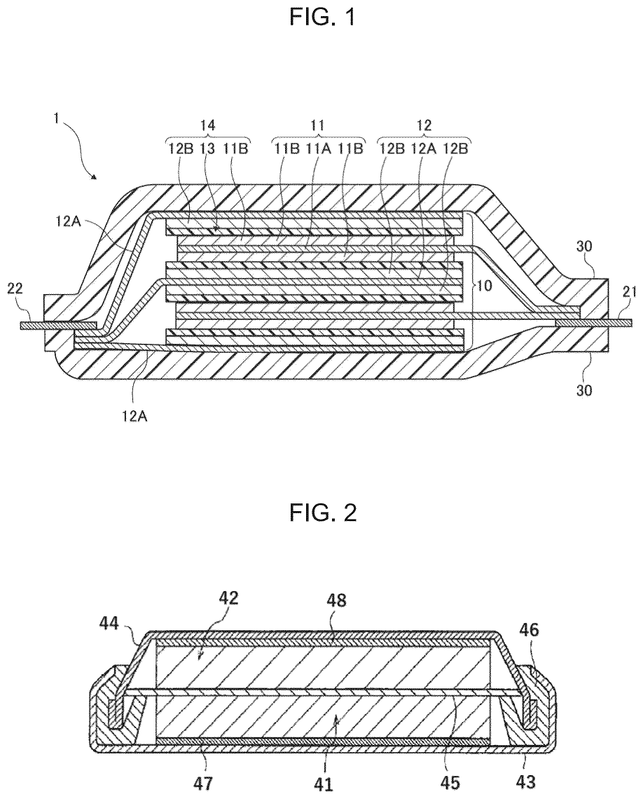

FIG. 1 is a schematic cross-sectional view illustrating a laminated-type lithium secondary battery precursor as one example of the lithium secondary battery precursor of the disclosure.

As illustrated in FIG. 1, a lithium secondary battery precursor 1 is a laminated-type battery precursor.

Specifically, a battery element 10 in the lithium secondary battery precursor 1 is encapsulated in an outer package 30. The outer package 30 is formed by a laminate film. Each of a positive electrode lead 21 and a negative electrode lead 22 is attached to the battery element 10. Each of the positive electrode lead 21 and the negative electrode lead 22 is led out in an opposite direction from the inside toward the outside of the outer package 30.

The battery element 10 is obtained by layering a positive electrode 11, a separator 13, and a negative electrode 12, as illustrated in FIG. 1. The positive electrode 11 is obtained by forming a positive electrode mixture layer 11B on each of both main surfaces of a positive electrode current collector 11A. The negative electrode 12 is obtained by forming a negative electrode mixture layer 12B on each of both main surfaces of a negative electrode current collector 12A. The positive electrode mixture layer 11B formed on one of the main surfaces of the positive electrode current collector 1I A of the positive electrode 11, and the negative electrode mixture laver 12B formed on one of the main surfaces of the negative electrode current collector 12A of the negative electrode 12 adjacent to the positive electrode 11 face to each other with the separator 13 being interposed.

The non-aqueous electrolytic solution of the disclosure is injected to the inside of the outer package 30 of the lithium secondary battery precursor 1. The non-aqueous electrolytic solution of the disclosure penetrates in the positive electrode mixture layer 11B, the separator 13, and the negative electrode mixture layer 12B. In the lithium secondary battery precursor 1, one single battery layer 14 is formed by the adjacent positive electrode mixture layer 11B, separator 13, and negative electrode mixture layer 12B. Each of the positive electrode and the negative electrode may be one in which the active material layer is formed on one surface of the current collector.

The lithium secondary battery precursor 1 is a laminated-type lithium secondary battery precursor, and the lithium secondary battery precursor of the disclosure is not limited thereto and may be, for example, a wound-type lithium secondary battery precursor. The wound-type lithium secondary battery precursor is obtained by stacking and winding the positive electrode, the separator, the negative electrode, and the separator in the listed order in a layered manner. The wound-type lithium secondary battery precursor encompasses a cylindrical lithium secondary battery precursor and a rectangular lithium secondary battery precursor.

As illustrated in FIG. 1, the direction in which each of the positive electrode lead and the negative electrode lead protrudes from the inside toward the outside of the outer package 30 in the lithium secondary battery precursor 1 is an opposite direction against the outer package 30, but the disclosure is not limited thereto. For example, the method in which each of the positive electrode lead and the negative electrode lead protrudes from the inside toward the outside of the outer package 30 may be in the same direction against the outer package 30.

One example of the lithium secondary battery of the disclosure, as described below, is a lithium secondary battery obtained by applying charge and discharge to the lithium secondary battery precursor 1.

FIG. 2 is a schematic cross-sectional view illustrating a coin-type lithium secondary battery precursor as another example of the lithium secondary battery precursor of the disclosure.

In a coin-type lithium secondary battery precursor illustrated in FIG. 2, a disk-shaped negative electrode 42, a separator 45 with the non-aqueous electrolytic solution injected thereinto, a disk-shaped positive electrode 41, and, if necessary, stainless or aluminum spacer plates 47 and 48, which are layered in the listed order, are received between a positive electrode can 43 (hereinafter, also referred to as “battery can”) and a sealing plate 44 (hereinafter, also referred to as “battery can lid”). The positive electrode can 43 and the sealing plate 44 are tightly sealed by swaging with a gasket 46 being interposed.

In such an example, the non-aqueous electrolytic solution of the disclosure is used as the non-aqueous electrolytic solution to be injected into the separator 45.

One example of the lithium secondary battery of the disclosure, as described below, is a lithium secondary battery obtained by applying charge and discharge to the coin-type lithium secondary battery precursor illustrated in FIG. 2.

### [Lithium Secondary Battery and Production Method Thereof]

The method of producing a lithium secondary battery of the disclosure includes a step of preparing the above-mentioned lithium secondary battery precursor of the disclosure (hereinafter, also referred to as “preparation step”), and a step of applying charge and discharge to the lithium secondary battery precursor.

The lithium secondary battery of the disclosure is a lithium secondary battery obtained by applying charge and discharge to the above lithium secondary battery precursor.

The lithium secondary battery and the production method thereof, of the disclosure, can allow for reduction in rate of increase in normal-temperature resistance during high-temperature storage of the lithium secondary battery.

The preparation step may be a step of only preparing the lithium secondary battery precursor of the disclosure, produced in advance, for the step of applying charge and discharge, or may be a step of producing the lithium secondary battery precursor of the disclosure.

The lithium secondary battery precursor is as described above.

The application of charge and discharge to the lithium secondary battery precursor in the step of applying charge and discharge can be performed according to a known method.

In this step, the application of a charge-discharge cycle to the lithium secondary battery precursor may be repeated multiple times.

As described above, such charge and discharge preferably allow a SEI (Solid Electrolyte Interface) film to be formed on surface(s) of the positive electrode (in particular, positive electrode active material) and/or the negative electrode (SEI (Solid Electrolyte Interface) film to be formed on a negative electrode active material) in the lithium secondary battery precursor.

The step of applying charge and discharge is preferably performed by applying a combination of charge and discharge to the lithium secondary battery precursor one or more times under an environment at 25 °C to 70 °C.

### EXAMPLES

Hereinafter, Examples of the disclosure are shown, but the disclosure is not limited to the following Examples.

Hereinafter, “%” means “% by mass”, unless particularly noted.

### Example 1-1

### <Preparation of Non-Aqueous Electrolytic Solution>

Ethylene carbonate (hereinafter. “EC”), dimethyl carbonate (hereinafter, “DMC”), and ethyl methyl carbonate (hereinafter, “EMC”) were mixed at EC:DMC:EMC═30:35:35 (volume ratio). Thus, a mixed solvent was obtained as a non-aqueous solvent.

LiPF₆ as an electrolyte was dissolved in the obtained mixed solvent so that the concentration in a finally obtained non-aqueous electrolytic solution was 1.2 mol/L, and thus an electrolytic solution (hereinafter, also referred to as “basic electrolytic solution”) was obtained.

1,3-Propenesultone (namely, compound (I-1)) as the additive A and lithium difluorophosphate (namely, compound (III-1)) as the additive B were each added to the obtained basic electrolytic solution so that the content with respect to the total amount of a finally obtained non-aqueous electrolytic solution was a content (% by mass) described in Table 1, and thus a non-aqueous electrolytic solution was obtained.

The compound (I-1) was a specific example of the compound (I) and lithium difluorophosphate (namely, compound (III-1)) was a specific example of the compound (III).

### <Production of Positive Electrode>

A mixture in which LiNi_{0.5}Co₀₂Mn_{0.3}O₂ (90% by mass) as a positive electrode active material,
carbon black (2.5% by mass) and graphite (2.5% by mass), as the conductive aid, and
polyvinylidene fluoride (PVdF) (5% by mass) as the binder were mixed was obtained. The obtained mixture was dispersed in an N-methylpyrrolidone solvent, to obtain a positive electrode mixture slurry.

Aluminum foil having a thickness of 20 μm was prepared as the positive electrode current collector.

The obtained positive electrode mixture slurry was applied onto the aluminum foil, dried, and rolled by a pressing machine, to obtain a sheet-shaped positive electrode. The positive electrode included the positive electrode current collector and a positive electrode active material layer.

### <Production of Negative Electrode>

Graphite (96% by mass) as the negative electrode active material, carbon black (1% by mass) as the conductive aid, 1% by mass in terms of solid content of sodium carboxymethylcellulose dispersed in pure water, as the thickener, and 2% by mass in terms of solid content of styrene-butadiene rubber (SBR) dispersed in pure water, as the binder, were mixed, to obtain a negative electrode mixture slurry.

Copper foil having a thickness of 10 μm was prepared as the negative electrode current collector.

The obtained negative electrode mixture slurry was applied onto the copper foil, dried, and rolled by a pressing machine, to obtain a sheet-shaped negative electrode. The negative electrode included the negative electrode current collector and a negative electrode active material layer.

### <Preparation of Separator>

A porous polyethylene film was prepared as the separator

### <Production of Lithium Secondary Battery Precursor>

The negative electrode, the positive electrode, and the separator were respectively punched into a disk shape having a diameter of 14 mm, a disk shape having a diameter of 13 mm, and a disk shape having a diameter of 17 mm. Thus, a coin-shaped negative electrode, a coin-shaped positive electrode, and a coin-shaped separator were respectively obtained.

The obtained coin-shaped negative electrode, coin-shaped separator, and coin-shaped positive electrode were layered in the listed order in a stainless battery can (size: 2032 size). Next, 20 μL of the non-aqueous electrolytic solution was injected into the battery can, and the separator, the positive electrode, and the negative electrode were impregnated with the non-aqueous electrolytic solution.

Next, an aluminum plate (thickness 1.2 mm, diameter 16 mm) and a spring were mounted on the positive electrode, and a battery can lid was swaged with a polypropylene gasket being interposed, to tightly seal a battery.

As described above, a coin-type lithium secondary battery precursor (namely, lithium secondary battery before application of charge and discharge) having a configuration illustrated in FIG. 2 was obtained. The size of the lithium secondary battery precursor had a diameter of 20 mm and a height of 3.2 mm.

### <Production of Lithium Secondary Battery>

A lithium secondary battery was obtained by applying to the lithium secondary battery precursor, charge to 4.2 V and discharge to 2.5 V repeatedly three times under a temperature range of from 25 °C to 70 °C.

### <Measurement of Initial Discharge Capacity>

Each of the lithium secondary batteries was charged to 4.2 V and then discharged to 2.5 V in a constant-temperature bath at 25 °C, and the discharge capacity [mAh] (hereinafter, also referred to as “initial discharge capacity”) was measured.

### <Measurement of Initial Resistance Value>

Each of the lithium secondary batteries after initial discharge capacity measurement was charged to 3.7 V and then each amount of reduction in voltage (=Voltage before discharge initiation−Voltage at 10 seconds after discharge initiation) by CC10s discharge at each discharge rate of from 0.1 C to 1.0 C was measured in a constant-temperature bath at 25 °C. The CC10s discharge here means discharge performed at a constant current (Constant Current) for 10 seconds. The DC resistance [Ω] as the initial resistance value was determined based on each amount of reduction in voltage, obtained, and each current value (namely, each current value corresponding to each discharge rate of from 0.1 C to 1.0 C).

### <Initial Resistance (Relative Value)>

The relative value in Example 1-1, under the assumption that the initial resistance value in Comparative Example 1-1 was 100, was determined and was defined as the initial resistance (relative value) in Example 1-1 (see the following expression).

Initial resistance in Example 1-1 (relative value)=(Initial resistance value in Example 1-1)/(Initial resistance value in Comparative Example 1-1)×100

### Examples 1-2 and 1-3, and Comparative Examples 1-2 and 1-3

The same operation as in Example 1-1 was performed except that the content(s) of the additive A and/or the additive B were/was changed as shown in Table 1.

The results are shown in Table 1.

### Comparative Example 1-1

The same operation as in Example 1-1 was performed except that the additive A was not used.

The results are shown in Table 1.

### Example 2-1

The same operation as in Example 1-1 was performed except that the type of the additive B was changed as shown in Table 1 and the relative value was determined as the initial resistance (relative value) under the assumption that the initial resistance value in Comparative Example 2-1 described below was 10.

The results are shown in Table 1.

The structure of the compound (II-1) as the additive B is as described above.

### Examples 2-2 and 2-3, and Comparative Examples 2-2 and 2-3

The same operation as in Example 2-1 was performed except that the content(s) of the additive A and/or the additive B were/was changed as shown in Table 1.

The results are shown in Table 1.

### Comparative Example 2-1

The same operation as in Example 2-1 was performed except that the additive A was not used.

The results are shown in Table 1.

### Example 3-1

The same operation as in Example 1-1 was performed except that the type of the additive B was changed as shown in Table 1 and the relative value was determined as the initial resistance (relative value) under the assumption that the initial resistance value in Comparative Example 3-1 described below was 100.

The results are shown in Table 1.

The structure of the compound (II-2) as the additive B is described above.

### Examples 3-2 and 3-3, and Comparative Examples 3-2 and 3-3

The same operation as in Example 3-1 was performed except that the content(s) of the additive A and/or the additive B were/was changed as shown in Table 1.

The results are shown in Table 1.

### Comparative Example 3-1

The same operation as in Example 3-1 was performed except that the additive A was not used.

The results are shown in Table 1.

### Example 4-1

The same operation as in Example 1-1 was performed except that the type of the additive B was changed as shown in Table 1, and the relative value was determined as the initial resistance (relative value) under the assumption that the initial resistance value in Comparative Example 4-1 described below was 100.

The results are shown in Table 1.

The structure of the compound (IV-1) as the additive B is as described above.

### Examples 4-2 and 4-3, and Comparative Examples 4-2 and 4-3

The same operation as in Example 4-1 was performed except that the content(s) of the additive A and/or the additive B were/was changed as shown in Table 1.

The results are shown in Table 1.

### Comparative Example 4-1

The same operation as in Example 4-1 was performed except that the additive A was not used.

The results are shown in Table 1.

TABLE 1

| | | | | | | | Content mass | Initial |
|---|---|---|---|---|---|---|---|---|
| | | | | | | | ratio | resistance |
| | Additive A | | | Additive B | | | [additive | (relative |
| | Class | Type | % by mass | Class | Type | % by mass | A/additive B] | value) |
| Comparative | — | — | — | Compound | Compound | 0.5 | | 100 |
| Example 1-1 | | | | (III) | (III-1) | | | |
| Comparative | Compound | Compound | 0.01 | | | 0.5 | 0.02 | 103 |
| Example 1-2 | (I) | (I-1) | | | | | | |
| Comparative | | | 0.5 | | | 0.5 | 1 | 104 |
| Example 1-3 | | | | | | | | |
| Example 1-1 | | | 0.05 | | | 0.8 | 0.06 | 94 |
| Example 1-2 | | | 0.05 | | | 0.5 | 0.1 | 89 |
| Example 1-3 | | | 0.2 | | | 0.5 | 0.4 | 80 |
| Comparative | — | — | | Compound | Compound | 0.5 | | 100 |
| Example 2-1 | | | | (II) | (II-1) | | | |
| Comparative | Compound | Compound | 0.01 | | | 0.5 | 0.02 | 101 |
| Example 2-2 | (I) | (I-1) | | | | | | |
| Comparative | | | 0.5 | | | 0.5 | 1 | 101 |
| Example 2-3 | | | | | | | | |
| Example 2-1 | | | 0.05 | | | 0.8 | 0.06 | 79 |
| Example 2-2 | | | 0.05 | | | 0.5 | 0.1 | 79 |
| Example 2-3 | | | 0.2 | | | 0.5 | 0.4 | 82 |
| Comparative | — | — | | Compound | Compound | 0.5 | | 100 |
| Example 3-1 | | | | (II) | (II-2) | | | |
| Comparative | Compound | Compound | 0.01 | | | 0.5 | 0.02 | 105 |
| Example 3-2 | (I) | (I-1) | | | | | | |
| Comparative | | | 0.5 | | | 0.5 | 1 | 110 |
| Example 3-3 | | | | | | | | |
| Example 3-1 | | | 0.05 | | | 0.8 | 0.06 | 89 |
| Example 3-2 | | | 0.05 | | | 0.5 | 0.1 | 69 |
| Example 3-3 | | | 0.2 | | | 0.5 | 0.4 | 84 |
| Comparative | — | — | | Compound | Compound | 0.5 | | 100 |
| Example 4-1 | | | | (IV) | (IV-2) | | | |
| Comparative | Compound | Compound | 0.01 | | | 0.5 | 0.02 | 103 |
| Example 4-2 | (I) | (I-1) | | | | | | |
| Comparative | | | 0.5 | | | 0.5 | 1 | 109 |
| Example 4-3 | | | | | | | | |
| Example 4-1 | | | 0.05 | | | 0.8 | 0.06 | 91 |
| Example 4-2 | | | 0.05 | | | 0.5 | 0.1 | 87 |
| Example 4-3 | | | 0.2 | | | 0.5 | 0.4 | 85 |

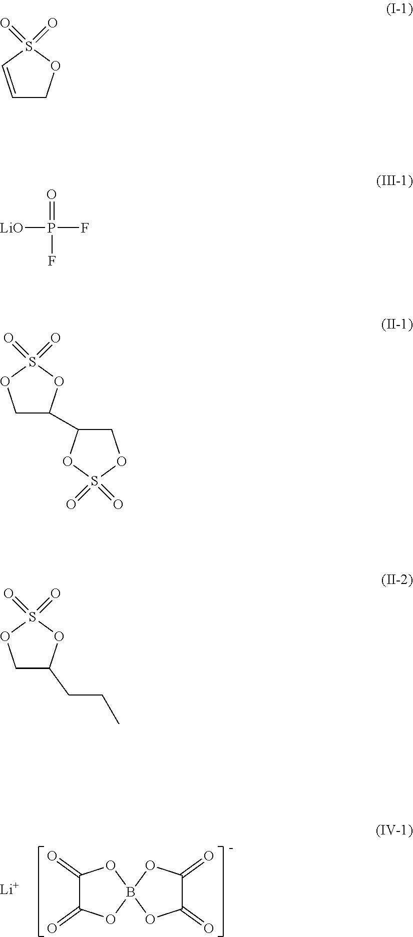

### Example 5-1

The same operation as in Example 1-1 was performed except that the type of the additive B was changed as shown in Table 2 and the relative value was determined as the initial resistance (relative value) under the assumption that the initial resistance value in Comparative Example 5-1 described below was 100.

The results are shown in Table 2.

The structure of the compound (V-I) as the additive B is as described above.

### Examples 5-2 and 5-3, and Comparative Examples 5-2 and 5-3

The same operation as in Example 5-1 was performed except that the content(s) of the additive A and/or the additive B were/was changed as shown in Table 2.

The results are shown in Table 2.

### Comparative Example 5-1

The same operation as in Example 5-1 was performed except that the additive A was not used.

The results are shown in Table 2.

### Example 6-1

The same operation as in Example 1-1 was performed except that the type of the additive B was changed as shown in Table 2 and the relative value was determined as the initial resistance (relative value) under the assumption that the initial resistance value in Comparative Example 6-1 described below was 100.

The results are shown in Table 2.

The structure of the compound (V-2) as the additive B is as described above.

### Examples 6-2 and 6-3, and Comparative Examples 6-2 and 6-3

The same operation as in Example 6-1 was performed except that the content(s) of the additive A and/or the additive B were/was changed as shown in Table 2.

The results are shown in Table 2.

### Comparative Example 6-1

The same operation as in Example 6-1 was performed except that the additive A was not used.

The results are shown in Table 2.

### Example 7-1

The same operation as in Example 1-1 was performed except that the type of the additive B was changed as shown in Table 2 and the relative value was determined as the initial resistance (relative value) under the assumption that the initial resistance value in Comparative Example 7-1 described below was 100.

The results are shown in Table 2.

The structure of the compound (VI-2) as the additive B is as described above.

### Examples 7-2 and 7-3, and Comparative Examples 7-2 and 7-3

The same operation as in Example 7-1 was performed except that the content(s) of the additive A and/or the additive B were/was changed as shown in Table 2.

The results are shown in Table 2.

### Comparative Example 7-1

The same operation as in Example 7-1 was performed except that the additive A was not used.

The results are shown in Table 2.

### Example 8-1

The same operation as in Example 1-1 was performed except that the type of the additive B was changed as shown in Table 2 and the relative value was determined as the initial resistance (relative value) under the assumption that the initial resistance value in Comparative Example 8-1 described below was 10.

The results are shown in Table 2.

The structure of the compound (VII-1) as the additive B is as described above.

### Examples 8-2 and 8-3, and Comparative Examples 8-2 and 8-3

The same operation as in Example 8-1 was performed except that the content(s) of the additive A and/or the additive B were/was changed as shown in Table 2.

The results are shown in Table 2.

### Comparative Example 8-1

The same operation as in Example 8-1 was performed except that the additive A was not used.

The results are shown in Table 2.

### Example 9-1

The same operation as in Example 1-1 was performed except that the type of the additive B was changed as shown in Table 2 and the relative value was determined as the initial resistance (relative value) under the assumption that the initial resistance value in Comparative Example 9-1 described below was 100.

The results are shown in Table 2.

The structure of the compound (VIII-1) as the additive B is as described above.

### Examples 9-2 and 9-3, and Comparative Examples 9-2 and 9-3

The same operation as in Example 9-1 was performed except that the content(s) of the additive A and/or the additive B were/was changed as shown in Table 2.

The results are shown in Table 2.

### Comparative Example 9-1

The same operation as in Example 9-1 was performed except that the additive A was not used.

The results are shown in Table 2.

TABLE 2

| | | | | | | | Content mass | Initial |
|---|---|---|---|---|---|---|---|---|
| | | | | | | | ratio | resistance |
| | Additive A | | | Additive B | | | [additive | (relative |
| | Class | Type | % by mass | Class | Type | % by mass | A/additive B] | value) |
| Comparative | — | — | — | Compound | Compound | 0.5 | | 100 |
| Example 5-1 | | | | (V) | (V-1) | | | |
| Comparative | Compound | Compound | 0.01 | | | 0.5 | 0.02 | 100 |
| Example 5-2 | (I) | (I-1) | | | | | | |
| Comparative | | | 0.5 | | | 0.5 | 1 | 98 |
| Example 5-3 | | | | | | | | |
| Example 5-1 | | | 0.05 | | | 0.8 | 0.06 | 77 |
| Example 5-2 | | | 0.05 | | | 0.5 | 0.1 | 85 |
| Example 5-3 | | | 0.2 | | | 0.5 | 0.4 | 90 |
| Comparative | — | — | | compound | compound | 0.5 | | 100 |
| Example 6-1 | | | | (V) | (V-2) | | | |
| Comparative | Compound | Compound | 0.01 | | | 0.5 | 0.02 | 102 |
| Example 6-2 | (I) | (I-1) | | | | | | |
| Comparative | | | 0.5 | | | 0.5 | 1 | 105 |
| Example 6-3 | | | | | | | | |
| Example 6-1 | | | 0.05 | | | 0.8 | 0.06 | 81 |
| Example 6-2 | | | 0.05 | | | 0.5 | 0.1 | 82 |
| Example 6-3 | | | 0.2 | | | 0.5 | 0.4 | 95 |
| Comparative | — | — | | Compound | Compound | 0.5 | | 100 |
| Example 7-1 | | | | (VI) | (VI-2) | | | |
| Comparative | Compound | Compound | 0.01 | | | 0.5 | 0.02 | 102 |
| Example 7-2 | (I) | (I-1) | | | | | | |
| Comparative | | | 0.5 | | | 0.5 | 1 | 102 |
| Example 7-3 | | | | | | | | |
| Example 7-1 | | | 0.05 | | | 0.8 | 0.06 | 88 |
| Example 7-2 | | | 0.05 | | | 0.5 | 0.1 | 82 |
| Example 7-3 | | | 0.2 | | | 0.5 | 0.4 | 96 |
| Comparative | — | — | | Compound | Compound | 0.5 | | 100 |
| Example 8-1 | | | | (VII) | (VII-1) | | | |
| Comparative | Compound | Compound | 0.01 | | | 0.5 | 0.02 | 101 |
| Example 8-2 | (I) | (I-1) | | | | | | |
| Comparative | | | 0.5 | | | 0.5 | 1 | 103 |
| Example 8-3 | | | | | | | | |
| Example 8-1 | | | 0.05 | | | 0.8 | 0.06 | 95 |
| Example 8-2 | | | 0.05 | | | 0.5 | 0.1 | 93 |
| Example 8-3 | | | 0.2 | | | 0.5 | 0.4 | 92 |
| Comparative | — | — | | Compound | Compound | 0.5 | | 100 |
| Example 9-1 | | | | (VIII) | (VIII-1) | | | |
| Comparative | Compound | Compound | 0.01 | | | 0.5 | 0.02 | 101 |
| Example 9-2 | (I) | (I-1) | | | | | | |
| Comparative | | | 0.5 | | | 0.5 | 1 | 109 |
| Example 9-3 | | | | | | | | |
| Example 9-1 | | | 0.05 | | | 0.8 | 0.0625 | 94 |
| Example 9-2 | | | 0.05 | | | 0.5 | 0.1 | 91 |
| Example 9-3 | | | 0.2 | | | 0.5 | 0.4 | 94 |

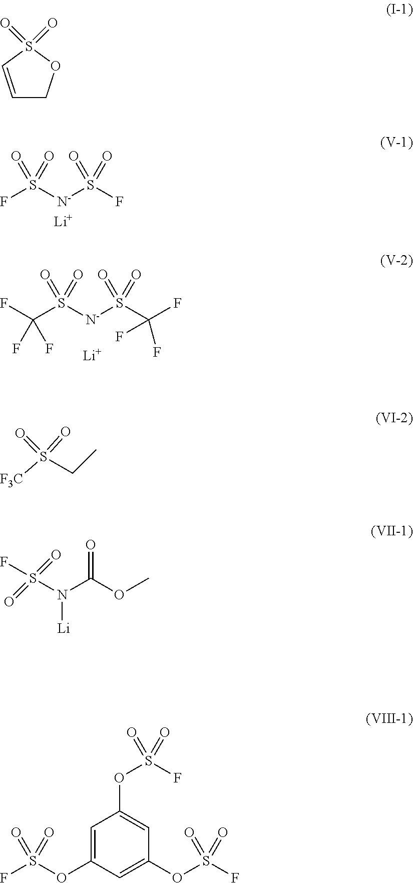

### Example 10-1

The same operation as in Example 1-1 was performed except that LiPF₆ as an electrolyte was dissolved so that the concentration in a finally obtained non-aqueous electrolytic solution was 1.0 mol/L, furthermore the compound (V-1) corresponding to the additive B was dissolved so that the concentration in a finally obtained non-aqueous electrolytic solution was 0.2 mol/L, the compound (I-1) as the additive A was added to the obtained basic electrolytic solution so that the content with respect to the total amount of a finally obtained non-aqueous electrolytic solution was a content (% by mass) described in Table 3, and the relative value was determined as the initial resistance (relative value) under the assumption that the initial resistance value in Comparative Example 10-1 described below was 100.

The results are shown in Table 3.

The structure of the compound (V-1) as the additive B is as described above.

### Examples 10-2 and 10-3, and Comparative Examples 10-2 and 10-3

The same operation as in Example 10-1 was performed except that the content(s) of the additive A and/or the additive B were/was changed as shown in Table 3.

The results are shown in Table 3.

### Comparative Example 10-1

The same operation as in Example 10-1 was performed except that the additive A was not used.

The results are shown in Table 3.

### Example 11-1

The same operation as in Example 1-1 was performed except that the type of the additive B used as the electrolyte was changed as shown in Table 3 and the relative value was determined as the initial resistance (relative value) under the assumption that the initial resistance value in Comparative Example 11-1 described below was 100.

The results are shown in Table 3.

The structure of the compound (V-2) as the additive B is as described above.

### Examples 11-2 and 11-3, and Comparative Examples 11-2 and 11-3

The same operation as in Example 11-1 was performed except that the content(s) of the additive A and/or the additive B were/was changed as shown in Table 3.

The results are shown in Table 3.

### Comparative Example 11-1

The same operation as in Example 11-1 was performed except that the additive A was not used.

The results are shown in Table 3.

TABLE 3

| | Additive A | | | Additive B | | | Initial resistance |
|---|---|---|---|---|---|---|---|
| | Class | Type | % by mass | Class | Type | M (mol/L) | (relative value) |
| Comparative | — | — | — | Compound | Compound | 0.2 | 100 |
| Example 10-1 | | | | (V) | (V-1) | | |
| Comparative | Compound | Compound | 0.01 | | | 0.2 | 102 |
| Example 10-2 | (I) | (I-1) | | | | | |
| Comparative | | | 0.5 | | | 0.2 | 108 |
| Example 10-3 | | | | | | | |
| Example 10-1 | | | 0.05 | | | 0.4 | 72 |
| Example 10-2 | | | 0.05 | | | 0.2 | 89 |
| Example 10-3 | | | 0.2 | | | 0.2 | 86 |
| Comparative | — | — | — | Compound | Compound | 0.2 | 100 |
| Example 11-1 | | | | (V) | (V-2) | | |
| Comparative | Compound | Compound | 0.01 | | | 0.2 | 103 |
| Example 11-2 | (I) | (I-1) | | | | | |
| Comparative | | | 0.5 | | | 0.2 | 108 |
| Example 11-3 | | | | | | | |
| Example 11-1 | | | 0.05 | | | 0.4 | 90 |
| Example 11-2 | | | 0.05 | | | 0.2 | 92 |
| Example 11-3 | | | 0.2 | | | 0.2 | 93 |

As shown in Table 1 to Table 3, each Example with the non-aqueous electrolytic solution for a battery, which contained the additive A as the compound (I) and the additive B as an additive other than the additive A and in which the content of the additive A, with respect to the total amount of the non-aqueous electrolytic solution for a battery, was from more than 0.01% by mass to less than 0.5% by mass, allowed for a reduction in initial resistance of a battery as compared with Comparative Example in which the additive A was not used, Comparative Example in which the content of the additive A was 0.01% by mass, and Comparative Example in which the content of the additive A was 0.5% by mass.

### REFERENCE SIGNS LISTS

1 lithium secondary battery precursor
10 battery element
11 positive electrode
11A positive electrode current collector
11B positive electrode mixture layer
12 negative electrode
12A negative electrode current collector
12B negative electrode mixture layer
13 separator
14 single battery layer
21 positive electrode lead
22 negative electrode lead
30 outer package
41 positive electrode
42 negative electrode
43 positive electrode can
44 sealing plate
45 separator
46 gasket
47, 48 spacer plate

The disclosure of Japanese Patent Application No. 2022-143268 filed on Sep. 8, 2022 is herein incorporated by reference in its entirety.

All documents, patent applications, and technical standards described herein are herein incorporated by reference, as if each individual document, patent application, and technical standard were specifically and individually indicated to be incorporated by reference.

1. A non-aqueous electrolytic solution for a battery, the solution comprising:
an additive A that is a compound (1) represented by the following Formula (I); and
an additive B that is at least one selected from the group consisting of a compound (II) represented by the following Formula (II), a compound (Ill) that is at least one of a monofluorophosphate or a difluorophosphate, a compound (IV) represented by the following Formula (IV), a compound (V) represented by the following Formula (V), a compound (VI) represented by the following Formula (VI), a compound (VII) represented by the following Formula (VII), and a compound (VIII) represented by the following Formula (VIII),
wherein a content of the additive A is from more than 0.01% by mass to less than 0.5% by mass with respect to a total amount of the non-aqueous electrolytic solution for a battery: 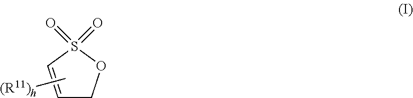
wherein, in Formula (I), each R¹¹ independently represents a fluoro group (—F), a hydrocarbon group having from 1 to 8 carbon atoms, optionally containing a fluoro group (—F) as a substituent, or a fluorocarbon group having from 1 to 8 carbon atoms, and h represents an integer from 0 to 4; 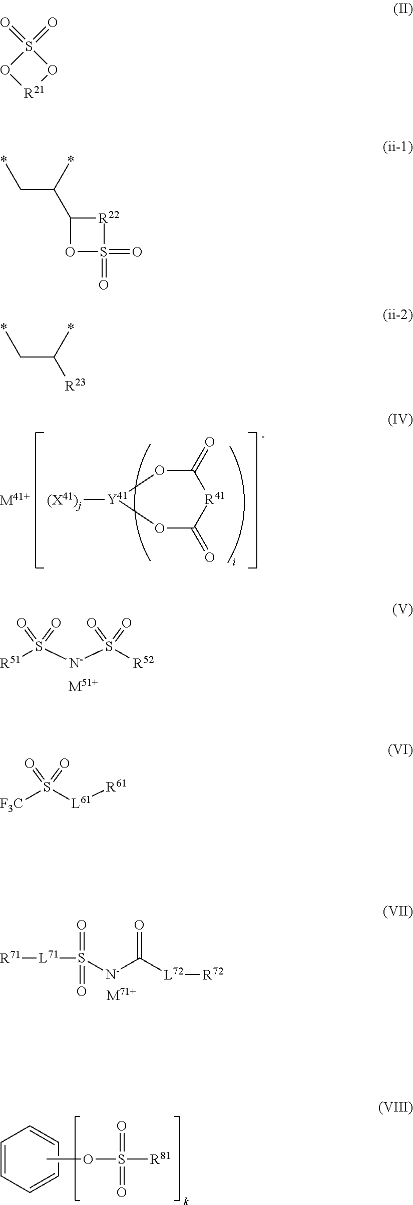
wherein, in Formula (II),
R²¹ represents a group represented by Formula (ii-1), a group represented by Formula (ii-2), or a divalent hydrocarbon group having from 3 to 6 carbon atoms,
* represents a binding position,
in Formula (ii-1), R²² represents an oxymethylene group (—OCH₂—), an oxyethylene group (—OCH₂CH₂—), an oxa group (—O—), or a divalent hydrocarbon group having from 1 to 6 carbon atoms, and
in Formula (ii-2), R²³ represents a hydrocarbon group having from 1 to 8 carbon atoms;
wherein, in Formula (IV),
M⁴¹⁺ represents an alkali metal ion,
each X⁴¹ independently represents a fluoro group (—F), a chloro group (—Cl), a bromo group (—Br), or an iodo group (—I),
Y⁴¹ represents a boron atom or a phosphorus atom,
each R⁴¹ independently represents a single bond (—), or a divalent hydrocarbon group having from 1 to 6 carbon atoms, optionally containing, as a substituent, at least one group selected from the group consisting of a fluoro group (—F), a chloro group (—Cl), a bromo group (—Br), and an iodo group (—I),
i represents 1 or 2 in a case in which the Y⁴¹ is a boron atom, or represents an integer from 1 to 3 in a case in which the Y⁴¹ is a phosphorus atom, and
j represents 0 or 2 in a case in which the Y⁴¹ is a boron atom, or represents 0, 2, or 4 in a case in which the Y⁴¹ is a phosphorus atom;
wherein, in Formula (V),
M⁵¹⁺ represents an alkali metal ion, and
each of R⁵¹ and R⁵² independently represents a fluoro group (—F), a hydrocarbon group having from 1 to 3 carbon atoms, optionally containing a fluoro group as a substituent, or a fluorocarbon group having from 1 to 3 carbon atoms;
wherein, in Formula (VI),
R⁶¹ represents a hydrocarbon group having from 1 to 8 carbon atoms, optionally containing, as a substituent, at least one group selected from the group consisting of a fluoro group (—F), a chloro group (—Cl), a bromo group (—Br), an iodo group (—I), an oxa group (—O—), a thio group (—S—), a secondary amino group (—NH—), a tertiary amino group (—N<), a carbonyl group (>C═O), and a sulfonyl group (>S(═O)₂), and
L⁶¹ represents a single bond (—) or an oxa group (—O—);
wherein, in Formula (VII),
M⁷¹⁺ represents an alkali metal ion,
each of R⁷¹ and R⁷² independently represents a fluoro group (—F), a chloro group (—Cl), a bromo group (—Br), an iodo group (—I), a hydrocarbon group having from 1 to 12 carbon atoms, optionally containing, as a substituent, at least one selected from the group consisting of a fluoro group (—F), a chloro group (—Cl), a bromo group (—Br), an iodo group (—I), and an oxa group (—O—), or a fluorocarbon group having from 1 to 8 carbon atoms, and
each of L⁷¹ and L⁷² represents a single bond (—) or an oxa group (—O—), and at least one of L⁷¹ or L⁷² is an oxa group (—O—); and
wherein, in Formula (VIII),
each R⁸¹ independently represents a fluoro group (—F), a chloro group (—Cl), a bromo group (—Br), or an iodo group (—I), and
k represents an integer from 1 to 6.

2. The non-aqueous electrolytic solution for a battery according to claim 1, wherein a content mass ratio of the additive A to the additive B (Content mass of additive A/Content mass of additive B) is from 0.05 to 0.5.

3. The non-aqueous electrolytic solution for a battery according to claim 1, wherein the content of the additive A is from 0.05% by mass to 0.4% by mass with respect to the total amount of the non-aqueous electrolytic solution for a battery.

4. The non-aqueous electrolytic solution for a battery according to claim 1, wherein a content of the additive B is from 0.01% by mass to 5.0% by mass with respect to the total amount of the non-aqueous electrolytic solution for a battery.

5. The non-aqueous electrolytic solution for a battery according to claim 1, comprising the compound (II) as the additive B,
wherein a content of the additive B is from 0.01% by mass to 5.0% by mass with respect to the total amount of the non-aqueous electrolytic solution for a battery.

6. The non-aqueous electrolytic solution for a battery according to claim 1, comprising the compound (Ill) as the additive B,
wherein a content mass ratio of the additive A to the additive B (Content mass of additive A/Content mass of additive B) is from 0.05 to 0.4.

7. The non-aqueous electrolytic solution for a battery according to claim 1, comprising the compound (IV) as the additive B,
wherein a content of the additive B is from 0.01% by mass to 5.0% by mass with respect to the total amount of the non-aqueous electrolytic solution for a battery.

8. The non-aqueous electrolytic solution for a battery according to claim 1, comprising the compound (V) as the additive B,
wherein a content of the additive B is from 0.1 mol/L to 6 mol/L with respect to the total amount of the non-aqueous electrolytic solution for a battery.

9. A lithium secondary battery precursor comprising:
a case; and
a positive electrode, a negative electrode, a separator, and an electrolytic solution, all of which are housed in the case, wherein:
the positive electrode is a positive electrode capable of occluding and releasing a lithium ion,
the negative electrode is a negative electrode capable of occluding and releasing a lithium ion, and
the electrolytic solution is the non-aqueous electrolytic solution for a battery according to claim 1.

10. The lithium secondary battery precursor according to claim 9, wherein the positive electrode comprises, as a positive electrode active material, a lithium-containing composite oxide represented by the following Formula (P1):
LiNiₐCo_{b}Mn_{c}O₂ Formula (P1)
wherein, in Formula (P1), each of a, b and c is independently from more than 0 to less than 1, and a total of a, b and c is from 0.99 to 1.00.

11. A method of producing a lithium secondary battery, the method comprising:
preparing the lithium secondary battery precursor according to claim 9; and
applying charge and discharge to the lithium secondary battery precursor.

12. A lithium secondary battery obtained by applying charge and discharge to the lithium secondary battery precursor according to claim 9.
